(19) United States
(12) Patent Application Publication
(10) Pub. No.: US 2014/0039954 A1
(43) Pub. Date: Feb. 6, 2014

(54) PROJECT MANAGEMENT WITH TASK TEMPLIFICATION AND CONCENTRATION, AND AUTOMATED PROVIDER IDENTIFICATION AND SCHEDULING

(71) Applicants: Dominic W. Wong, Morrisville, NC (US); Joseph Stephan Farrell, Cary, NC (US)

(72) Inventors: Dominic W. Wong, Morrisville, NC (US); Joseph Stephan Farrell, Cary, NC (US)

(73) Assignee: WJ GLOBAL LLC, Morrisville, NC (US)

(21) Appl. No.: 13/933,733

(22) Filed: Jul. 2, 2013

Related U.S. Application Data
(60) Provisional application No. 61/677,670, filed on Jul. 31, 2012.

(51) Int. Cl. G06Q 10/06

(52) U.S. Cl. CPC G06Q 10/063118
USPC 705/7.14; 705/7.17; 705/7.15

(57) ABSTRACT

Computer-implemented methods are disclosed to enhance implementation of a project where materials and services need to be provided at multiple locations and/or at multiple times. Using computer systems and communication networks, similar tasks to be iteratively performed are concentrated or collected in a task group. Electronic request transmissions are sent to providers identified to provide the materials and services, electronic responses to the requests are elicited from the providers, and the responses are automatically reviewed to determine that providers will provide the materials as needed. Criteria may be specified and used to automatically rank suitability of the one or more providers that may be used, and one or more objectives may be specified to automatically generate a schedule including the providers to be used.

This application claims the benefit of U.S. Provisional Patent Application No. 61/677,670 filed Jul. 31, 2012 under the provisions of 35 USC 119. The disclosure of U.S. Provisional Patent Application No. 61/677,670 is hereby incorporated herein by reference, in its entirety, for all purposes.

The present disclosure relates to project management. More specifically, the present disclosure relates to efficiently discharging the numerous tasks that may be involved in executing a project at a number of different implementation sites, including facilitating the identification, selection, and management of providers that may be relied upon to assist in the execution of the project.

### BACKGROUND

Managing deployment of a project may involve a number of discrete tasks. For example, site preparation and installation new equipment at a single location may require a site survey, ordering of materials, selecting of an installer, scheduling installation with the installer, checking on the delivery of materials, confirming installation dates, and, confirming installation, just to name some of the activities that may be involved. When the project is being implemented at one site or a few closely located sites, with sufficient time, a single project manager may be able to manage each of these tasks.

However, when the number of tasks involved or the number of implementation sites increases, or when the implementation sites are distributed over an increasingly larger area, it may not be possible for a single person to manage the deployment of the project. Multiple project managers may need to be assigned to plan, coordinate, and manage all implementation activities. In other words, it may require multiple skilled managers applying their skills at similar, repeated tasks in order to manage the implementation of the project at each of the sites for which each of the managers is responsible.

Involving multiple skilled project managers may stretch the resources of a project management organization. Involving multiple project managers also may significantly increase the costs of implementing the project. Moreover, involving multiple project managers may make it difficult to identify which project manager should be the point of contact—both for the client and for other providers of goods and services—when problems arise at one or more of the implementation sites.

Increasing the number of sites involved in the project not only multiplies the number of tasks involved in managing the project, but also may make some of the individual tasks more difficult to perform. For example, when multiple implementations are to be made in one locality, it may be possible to engage a single provider to provide materials or services to complete the implementation at each of the locations. However, when multiple localities are involved, multiple providers may have to be engaged. In a single locality, it may be difficult to identify a single provider in a single locality that has the desired skill, experience, and demonstrated record of quality work at a desired price point, or to identify which of a number of available providers might be best for the job; when numerous localities are involved, identifying proven providers and selecting one of them may be very difficult. Further, if one or more selected providers cannot provide the agreed-upon materials or services, quickly finding replacements for those contractors might prove to be a significant issue.

A great deal of time is required of project management personnel to identify providers—and to identify additional providers when initially-identified providers are not able to provide the needed materials or services. Even more project management time is needed to contact the providers, determine availability of providers, confirm orders and schedules, contact secondary providers when initially-identified providers are not available, etc. Further, when a project is to be implemented at multiple locations, one or more providers may be used to provide materials or services at multiple locations. It may be challenging to identify which providers should be used at which locations in order to implement the project cost-effectively in order to satisfy client deadlines and also ensure that the materials and services with satisfy desired quality requirements.

It would therefore be a significant advance in the art of project management to be able to execute the project using a minimum number of project managers without skipping or neglecting all of the tasks that may be appropriate in managing the project. It also would be a significant advance in the art of project management to facilitate the identification and selection of providers that may be relied upon to implement the project at numerous locations.

### SUMMARY

Computer-implemented methods are disclosed to enhance implementation of a project where materials and services need to be provided at multiple locations and/or at multiple times. Using computer systems and communication networks, similar tasks to be iteratively performed are concentrated or collected in a task group. Electronic request transmissions are sent to providers identified to provide the materials and services, and electronic responses to the requests are elicited from the providers. The responses are automatically reviewed to determine that providers will provide the materials as needed. In addition, the computer system may access a database that maintains information about providers that may perform particular tasks, such as providing materials or services to implement the tasks. Using one or more identified criteria for the performance of the particular tasks, such as experience, cost, etc., the providers are automatically ranked so as to generate a ranked list of providers that may be used to perform the particular tasks. In addition, objectives for implementing a project at a plurality of locations, such as costs, deadlines, etc., may be identified, and a schedule may be generated to coordinate the activities of providers to serve the identified objectives.

In a particular embodiment, a computer-implemented method for implementing a project at a plurality of locations, comprises the computer-implemented method comprises using a computer system configured to communicate electronically over one or more networks. The project is divided into a plurality of tasks for each of the plurality of locations, and the plurality of tasks are stored in a database of the computer system. Similar tasks for each of the plurality of locations are concentrated such that similar tasks across the plurality of locations are collected in a task group. For each particular task of the similar task in the task group, one or more electronic request transmissions are automatically generated to each particular provider of one or more providers selected to request provision of at least one of services and materials for performance of the particular task. One or more electronic responses to the one or more electronic request transmissions are received. The one or more electronic responses to the one or more electronic request transmissions are automatically reviewed to determine whether each of the one or more providers has generated a positive response to the one or more electronic request transmissions requesting the provision of the at least one of services and materials.

In another particular embodiment, a computer-implemented method for implementing a project at a plurality of locations comprises using a computer system to, for each particular task of a plurality of tasks for each of a plurality of locations involved in implementing a project, identify one or more providers listed in a database in communication with the computer system, where the one or more providers are identified as being capable of performing the particular task. One or more criteria are identified to be used in ranking the one or more providers. The one or more providers are automatically ranked according to the one or more criteria. A ranked list of the one or more providers to perform the particular task is thus generated.

In yet another particular embodiment, a computer-implemented method for implementing a project at a plurality of locations comprises using a computer system in communication with a provider database maintaining information about one or more providers potentially being capable of providing at least one of goods and services at one or more of the plurality of locations. One or more objectives are identified for generating a schedule to be used in scheduling performing one or more tasks involved in implementing a project at a plurality of locations. One or more providers are identified from a plurality of providers listed in the provider database where the one or more providers are identified as being capable of performing one or more particular tasks at one or more of the plurality of locations. The schedule for performing the one or more particular tasks at each of the plurality of locations is automatically generated so as to identify a selected provider for each of the plurality of locations from the one or more providers identified as being capable of performing the one or more particular tasks to satisfy the one or more objectives.

Other aspects, features and embodiments of the disclosure will be more fully apparent from the ensuing disclosure and appended claims.

### BRIEF DESCRIPTION OF THE DRAWINGS

FIG. 1 is a block diagram contrasting a conventional process for implementing a project in which one or more project managers oversee all aspects of a project with an embodiment of a process for templification and concentration of tasks according to the present disclosure;

FIG. 2 (Prior Art) is a block diagram of a method of discharging tasks in implementing a project using a conventional project management process;

FIG. 3 is a block diagram of a method of discharging tasks in implementing a project using an embodiment of a process for templification and concentration of tasks according to the present disclosure;

FIG. 4 is a block diagram of a computer system that may be utilized in implementing an embodiment of a process of templification and concentration of tasks according to the present disclosure;

FIG. 5 is a block diagram illustrating how use of a computer system and other electronic information resources may be employed by project management personnel to communicate with and to manage a plurality of providers;

FIG. 6 is a diagram of a plurality of exemplary, automated electronic request transmissions and electronic responses that may be exchanged between a computer system and a plurality of providers;

FIG. 7 is a block diagram illustrating the use of a computer system in automating the collection of electronic responses from a plurality of providers to facilitate client reporting, invoicing, and billing;

FIG. 8 is a block diagram of depicting implementation of project management system in the form or computer-executable instructions stored on a computer-readable medium being deployed on a computer system maintained within an enterprise;

FIG. 9 is a block diagram depicting implementation of a project management system in the form of an online service being accessible by project management personnel and providers;

FIG. 10 is a provider map that identifies locations of providers relative to a project location with cost, experience, and satisfaction information about the providers;

FIG. 11 is a provider map from which a number of potential providers has been filtered according to one or more criteria;

FIG. 12 is a provider map illustrating results of automatic sorting of potential providers according to two different sets of criteria;

FIG. 13 is a diagram showing a ranked list of identified providers enabling automatic selection of secondary and tertiary providers should higher-ranked providers fail to respond to requests or fail to perform a particular task;

FIG. 14 is a diagram depicting an initial schedule for implementation of a project using one of a plurality of providers;

FIG. 15 is a diagram of a revised schedule for implementation of a project that satisfies one or more identified objectives in generating the schedule;

FIG. 16 is a flow diagram of a particular embodiment of a method of performing project management using task templification and concentration and automated electronic communications;

FIG. 17 is a flow diagram of a particular embodiment of a method of automatically ranking potential providers according to one or more specified criteria to generate a ranked list of providers;

FIG. 18 is a flow diagram of a particular embodiment of a method of identifying providers available to perform implementation of a task and automatically generating a schedule for the identified providers that satisfied one or more objectives; and

FIG. 19 is a block diagram of an exemplary computing system for performing computer-implemented methods or executing computer-executable instructions according to the present disclosure.

### DETAILED DESCRIPTION

The systems and methods of the present disclosure improve the efficiency of project management and provide particular advantages in those phases of project management involving the identification and selection of providers to perform activities involved in implementation of a project; using electronic transmission requests and responses to facilitate automated review of provider's performance of tasks; automatic ranking of providers according to one or more identified criteria to generate a ranked list of providers; and automatic generation of a schedule for identified providers to satisfy one of more objectives.

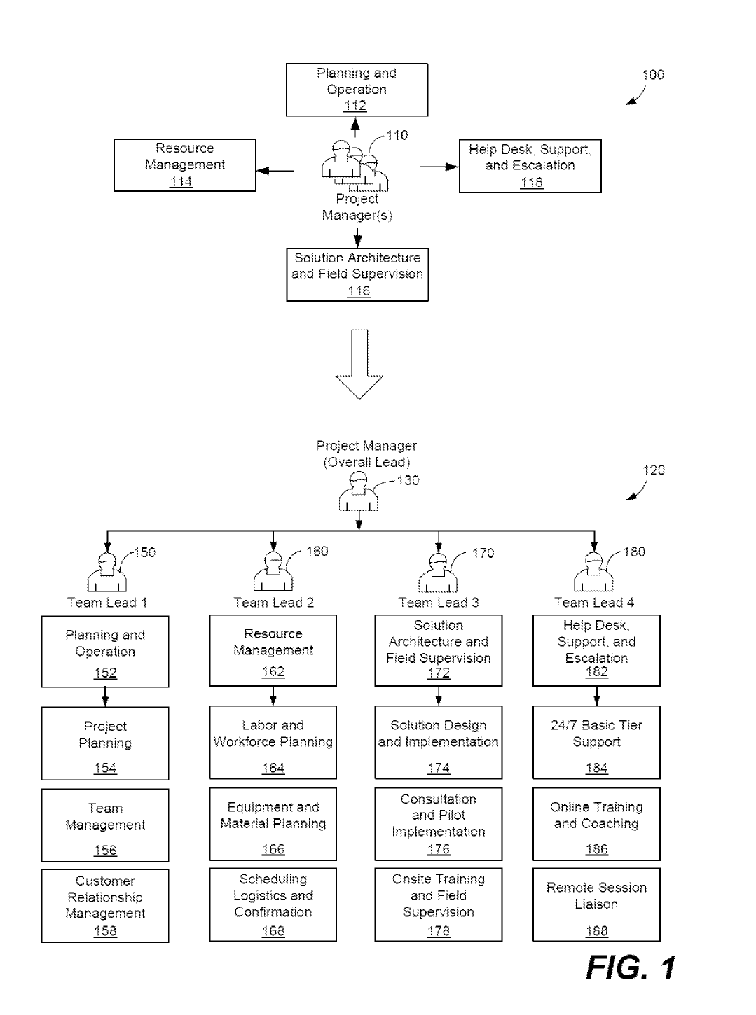

By way of overview of embodiments of the disclosure, FIG. 1 is a block diagram contrasting a conventional process 100 for implementing a project, in which one or more project managers oversee all aspects of a project, with an embodiment of a process for templification and concentration of tasks 120 according to the present disclosure.

In the conventional process 100, each of the one or more project managers 110 may be charged with all of the responsibilities for implementing the project in each of the locations for which each is responsible. For the sake of example, each of the responsibilities is divided into four different categories. First, each of the project managers 110 may be responsible for planning and operation 112, which may include identifying each of the steps needed to implement the project and what materials and services, will be used in implementing the project. Second, each of the project managers 110 also may be responsible for resource management 114, in which the project managers will identify and select providers of materials and services to implement the project. Third, each of the project managers 110 may be responsible for solution architecture and field supervision 116, which may include scheduling the shipment of materials and attendance of service providers, confirming the availability of the providers (and identifying alternate providers as needed), confirming the preparedness of the materials and service providers, confirming initiation of the implementation, confirming completion of each implementation phase, payment of providers, etc. Fourth, each of the project managers 110 also may be responsible for help desk, support, and escalation 118, which may include liaising with the client and the various service providers to answer questions and address problems as they arise, such as when needed materials are not delivered, service providers do not appear as scheduled, etc.

As further described with reference to the embodiment of a process for templification and concentration of tasks 120, each of the groups of categories of responsibilities 112, 114, 116, and 118 may itself include a wide range of tasks, resulting in each of the project managers 110 being equally responsible for a number of similar tasks. As a result, the conventional process 100 may be very time- and labor-intensive for the project managers 110. For example, as part of addressing the category of responsibilities under resource management 114, each of the project managers 110 may spend a great deal of their time in communicating with providers, such as by contacting material and service providers to engage them for the project, confirm availability, confirm arrival and completion, and other steps. Each of the project managers 110 may spend a great deal of time accounting for changes, such as by identifying and selecting alternative providers when a previously-identified provider is not available or fails to perform as agreed. Similarly, each of the project managers 110 may spend a great deal of time summarizing what aspects of the project are ready to be implemented, are being implemented, and have been implemented, in order to prepare reports status for the client.

Regrettably, investing so much of the time of the project managers 110 may not be a good use of a valuable resource. Many project managers are highly educated, well-trained, and have appropriate experience to plan and generally oversee a project. Thus, having these managers engaging in repetitive tasks, such as contacting providers, may not be a good use of a valuable resource.

Similarly, a large project may involve multiple project managers 110 performing tasks that are duplicative in nature to that performed by other project managers for different locations. For example, two or more different project managers may spend time in identifying providers that are available to supply a particular material, in addition to discharging their other responsibilities. It may be wasteful for multiple project managers to educate themselves regarding a particular material and regarding suitable providers in that area, instead of vesting responsibility for discharging similar tasks in one project manager or, at least, a subset of project managers.

According to an embodiment of the process for templification and concentration of tasks 120, some duplication of effort and consumption of valuable resources may be avoided. In the process 120, for example, a single, skilled project manager 130 may serve as an overall lead for an entire project. Reporting to the project manager 130 may be a plurality of team leaders 150, 160, 170, and 180. Each of the team leaders 150, 160, 170, and 180 may be responsible for particular tasks or sets of tasks (with additional personnel, not shown in FIG. 1, being assigned specific responsibilities in fulfilling the tasks or set of tasks assigned to the team).

For example, team lead 1 150 may be tasked generally with responsibility for planning and operation 152. Team lead 1 150 thus may be tasked with project planning 154, team management 156 in terms of managing the internal team of the team leaders 150, 160, 170, and 180, and customer relationship management 158 in terms of liaising with the client in reporting on the status of the project. Team lead 2 160 may be responsible for separate tasks in the area of resource management 162. Team lead 2 160 thus may be responsible for labor and workforce planning 164 in identifying appropriate service providers, equipment and material planning 166 in terms of identifying materials needed and what providers may be relied upon to deliver the same, and scheduling and logistics confirmation 168 in terms of scheduling the providers and confirming the provision of materials and services. Team lead 3 170 may be tasked with separate other responsibilities for solution architecture and field supervision 172, including responsibility for solution design and implementation 174, consultation and pilot implementation 176, and onsite training and field supervision 178. Finally, team lead 4 180 may be tasked with the separate tasks of help desk, support, and escalation 182. Team lead 4 180 thus may be tasked with 24/7 basic tier support 184 as well as online training and coaching 186. Team lead 4 180 also may be tasked with responsibility for providing a remote session liaison 188.

Thus, as described with reference to the embodiment of the process for templification and concentration of tasks 120, the project manager or managers 130 may delegate to team leaders 150, 160, 170, and 180 the responsibility for each of a category of responsibilities, 152, 162, 172, and 182, respectively. Thus, the project manager or managers 130 are free to concentrate on high level tasks in terms of planning, escalated concerns, etc. Specific groups of tasks may be delegated to potentially less scarce or less costly personnel. These personnel can focus on particular tasks and particular groups of tasks. Moreover, these personnel will focus on particular tasks without duplicating the types of tasks performed by others. All of these effects may therefore improve the efficiency of project implementation.

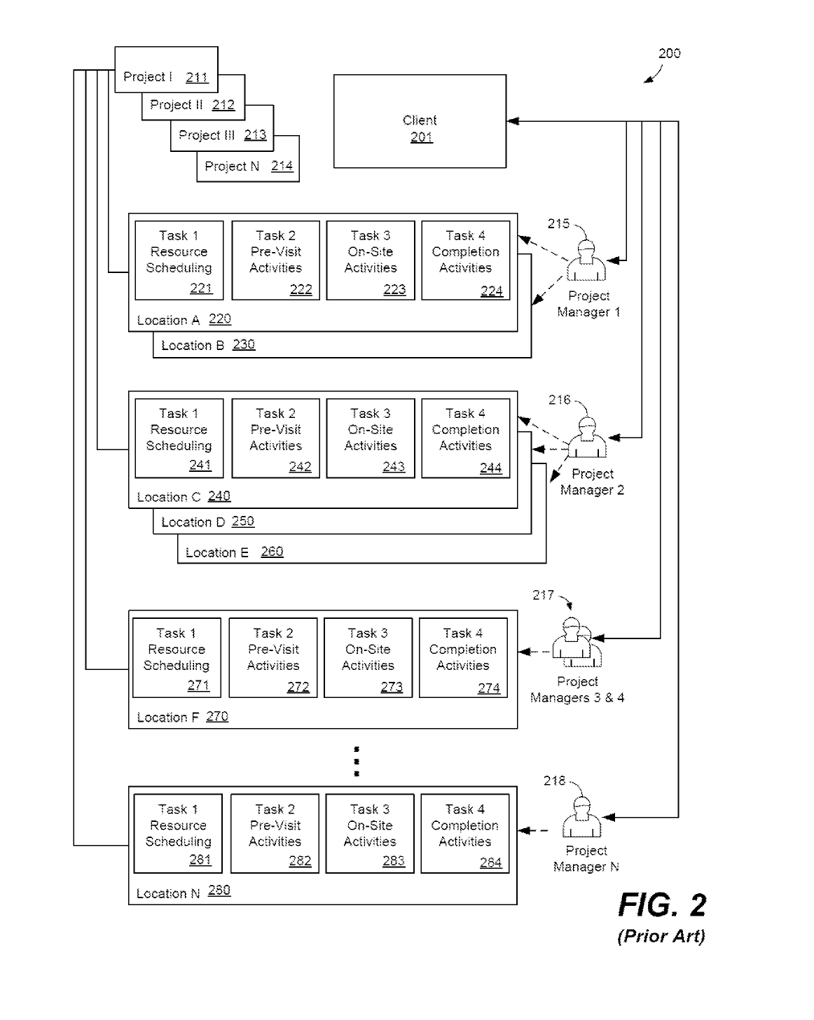

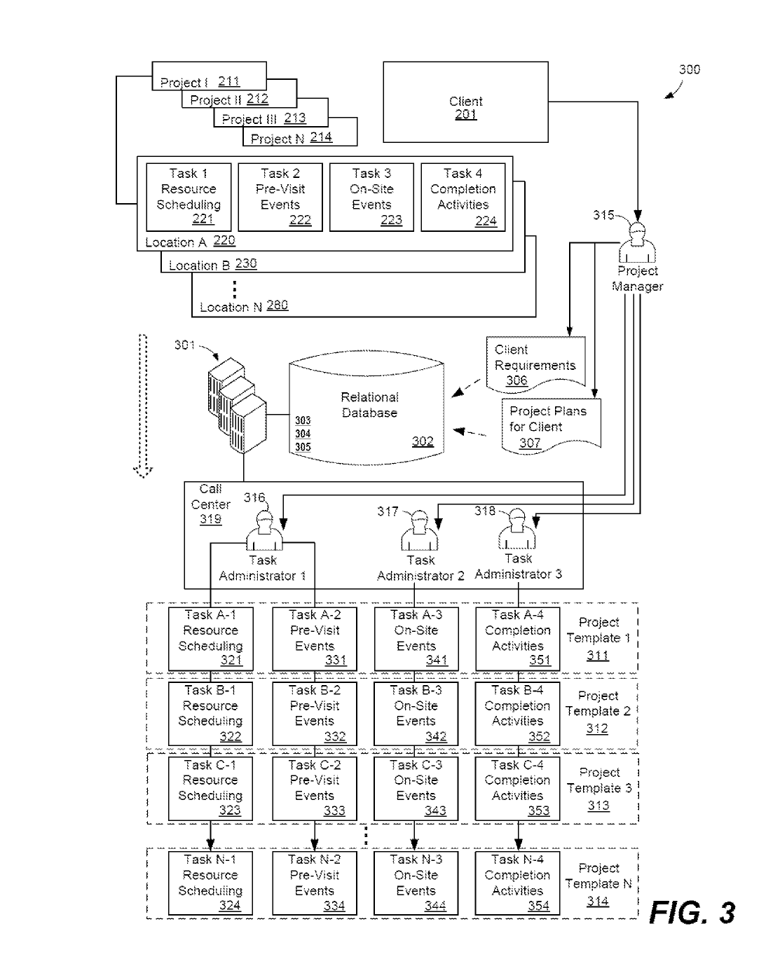

FIGS. 2 and 3 further contrast a conventional project management system and embodiments of a project management system according to the present disclosure. FIG. 2 depicts a conventional project management system 100 in which a project is managed by a plurality of project managers according to a conventional process of project management. The description of a conventional process or project management is included to highlight differences in and advantages of project management as performed according to presently disclosed embodiments of project management, as further described below.

In the system 200, a client 201 may have multiple projects to be implemented, including the Project I 211, Project II 212, Project III 213, up to Project N 214. Each of the projects 211-114 may involve performing multiple activities at multiple locations. For example, Project I 211 may involve performing activities at Locations A 220 through N 280. Managing the project activities may include resource scheduling 221, pre-visit activities 222, on-site activities 223, and completion activities 224. A first project manager 215 may be assigned to manage the tasks 221-224 at Location A 220 and to manage similar tasks at Location B 230.

The project also may involve performing similar activities at Location C 240, Location D 250, Location E 260, Location F 270, through Location N 280. A second project manager 216 may be assigned to manage the tasks of resource scheduling 241, pre-visit activities 242, on-site activities 243, and completion activities 244, to be performed at Location C 240 and to perform similar tasks at Location D 250 and Location E 260. The project also may involve performing similar activities at Location F 270 through Location N 280. To manage performance of the activities, management of tasks 271-274 and 281-284 may be assigned to additional project managers 217 and 218.

Assignment of project managers 215-218 may be based on the relative abilities of the project managers, anticipated complexities with managing tasks at particular locations, or other factors. Thus, while the first project manager 215 may be assigned with managing the project at two locations, Location A 220 and Location B 230, the second project manager 216 may be assigned with managing the project at three locations, Locations C-E 240-260. At the same time, third and fourth project managers 217 may be assigned to manage the project at Location F 270, while an Nth project manager 218 may be assigned to manage the project at a single location, Location N 280. Staffing implementation of the project at Locations A-N 220-280 thus may require a 3substantial number of trained project managers. Each of the project management tasks may be necessary and important to ensuring that the project is implemented on-time, within the budget, and without undue interruption in client business. Nonetheless, the involvement of such a substantial number of trained project managers may be costly to the client and may prove difficult for the project management organization to staff.

Reviewing the conventional project management methodology employed in the system 200 of FIG. 1, one should note that each of the project managers 215-218 may perform a number of repetitive tasks. For example, in addition to performing the tasks of resource scheduling 221, pre-visit activities 222, on-site activities 223, and completion activities 224 at Location A 220, the first project manager 215 may perform highly similar tasks at Location B 230. In addition to performing the tasks of resource scheduling 241, pre-visit activities 242, on-site activities 243, and completion activities 244 at Location C 240, the second project manager 216 may perform highly similar tasks at both Location D 250 and Location E 260. Thus, each of the project managers 215 and 216 may be repeatedly performing similar tasks. Further, all of the project managers 215-118 may be performing tasks that are very similar or repetitive of what the other project managers are doing.

Although each of the individual tasks may be inherent in sound project management to ensure a smooth implementation, some of these tasks may not require the time and skill of a trained project manager, let alone require that such a project manager repeatedly perform similar tasks. For example, sending directions and the name of the individual to whom the provider should report may be delegated to a less skilled individual, automated, or partially automated to support a less skilled individual in performing such a task. Other events, such as placing a telephone call to a provider to confirm that the provider is ready and will appear at the assigned time and place, may be important, but also may be readily handled by an individual without the skills—or inherent costs—of having such a call placed by a trained project manager.

Such delegable tasks may be assigned to a task administrator. A task administrator may not have the education, experience, and resourcefulness to be able to plan and fully oversee project implementation. However, a task administrator may be trained in one or a few facets of tasks to be performed, such as contacting providers to confirm preparedness. Task administrators, who may not direct client contact or responsibilities, may be located at a remote facility, such as a call center, in a rural location or an overseas location, with relatively low overhead costs. Thus, some delegable tasks may be delegated to lower cost personnel to make project management less costly and, as explained further below, more effective.

Assigning one or more task administrators to perform delegable tasks may free the project manager to focus her attention on other matters. For example, with one or more task administrators handling routine confirmatory communications with providers, the project manager is free to handle exceptions, e.g., unanticipated problems with materials, providers, or client situations. Freeing the project manager to handle such exceptions may enable the project manager to quickly handle higher exposure activities, which may improve client satisfaction. At the same time, assigning expected tasks to task administrators ensures those expected tasks will be performed even when the project manager is immersed in crises that may consume all of her time.

Further, freeing the project manager from delegable tasks may enable the project manager to manage more implementations or more projects. Involving fewer project managers in implementing a project may reduce the costs of managing the project without sacrificing any of the tasks that are important to sound project management. Project management thus may become less expensive for clients, more profitable for the project management organization, or both.

FIG. 3 depicts a system 300 in which a project is managed using task templification and concentration according to an implementation of the present disclosure. As in the system 200 of FIG. 2, it is assumed that the client 201 has multiple projects 211-214 to be implemented and that implementation of Project I 211 involves the performance of the same number of tasks at the same number of locations. Thus, as described with reference to FIG. 2 and shown in FIG. 3, resource scheduling 221, pre-visit activities 222, on-site activities 223, and completion activities 224 are to be performed at Location A 220, and similar tasks will have to be performed for Locations B-N 230-280.

According to embodiments of the present disclosure, templification of a task includes memorializing steps used to perform a particular process so that a computing system or an administrator has an established procedure for performing the task. For example, where the task includes installation of a particular device, templification of the task may generally include the following steps: finding a suitable provider of the device; ordering and arranging shipment of the device to a particular location; ordering supporting hardware or other components needed to install the device; identifying a suitable installer who is available at a selected time to install the device; confirming proper installation and function of the device; and paying the providers of the materials and services used. Thus, if installation of a particular device is to be performed at thousands of locations, the task of arranging each installation can be managed according to the foregoing template. Further, as described below, related tasks represented by separate elements on the templates may be assigned to one person or group so that multiple people or groups do not have to develop expertise in executing a portion of the template. For example, verifying that the device works correctly after installation may be performed by one person, one group of people, or one computing system that can become facile at performing such testing and, thus, may perform the testing very efficiently across the numerous implementation locations. Thus, templification of project tasks may enable a project to be performed efficiently.

It should be appreciated that the exemplary template listed in the foregoing paragraphs only includes a few steps. It is possible that an implementation at a particular location may include dozens or hundreds of steps. Such an involved task requiring many steps presents all the more reason for templification of a task so as to have a standard procedure to be followed for each instance of an implementation and, when possible, to group similar tasks for multiple instances in a person, group, or system who can become expert at one or more tasks.

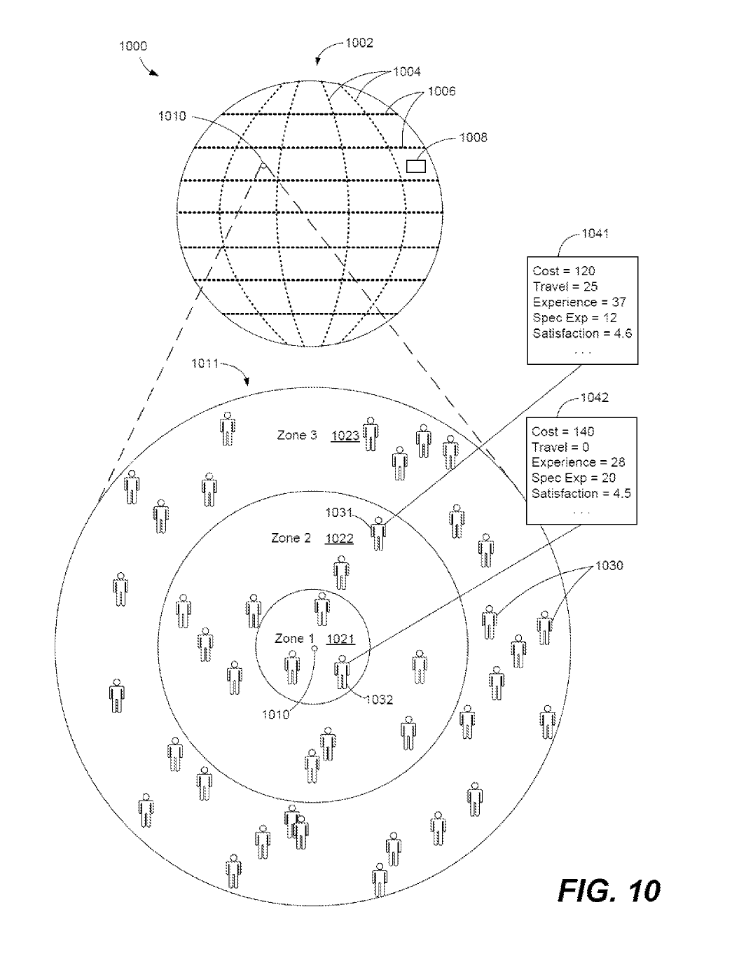

According to an illustrative embodiment of the disclosure, using a server system 201 and a staff of task administrators 316-318, a single project manager 315 may be able to manage Project I 211 at each of Locations A 220 through N 280. The server 301, which may include a network of server devices, interfaces with a relational database 302 that incorporates all data related to the projects to be implemented, including standardized information that the project manager 315 may utilize across many types of projects. For example, the relational database 302 may include standards 303 observed by the project management enterprise, templates 304 used to outline each of the individual tasks to be performed in managing the project, and information regarding providers 305 that may be engaged to perform activities included in the project. For example, the standards 303 may include lists of client communications and provider communications to be performed, how completion of a particular implementation is to be validated to ensure completion and client satisfaction, etc. The templates 304 may include checklists that incorporate requirements imposed by the standards 303 as well as templates for e-mails and other standardized communications to be conducted with the client 201 and the providers. The information on providers 305, which is described further with reference to FIGS. 10-13, includes information regarding the cost, location, experience, satisfaction ratings, and other information about providers that may be used to implement the projects at particular locations.

In addition to the standardized information that may be included in the relational database 302, the relational database 302 also may include particular information related to Project I 211 and the client 201. For example, information about client requirements 306 or plans for implementation of the project 307 collected or created by the project manager 315 may be added to the relational database 302. The client requirements 306 may include particular conduct required of providers, particular types of reports the client 201 desires or demands, particular types of validation of completion desired, etc. The project plans 307 may include plans specified by the client 201 or created by the project manager 315 to detail how the project is to be implemented. The client requirements 306 and project plans 307 may be added to the standards 303 and templates 304 stored in the relational database 302 or may be separately stored in to augment the standards 303 and templates 304. In addition, although not shown in FIG. 3, the client 101 may provide information about particular desired or undesired providers or criteria demanded or preferred by the client 101 that may be used to augment, filter, or rank providers included in the information on providers 305.

The server 301 and the relational database 302 facilitate the templification and concentration of tasks in the task administrators 316-318. Based on the standards 303, templates 304, information on providers 305, client requirements 306, and project plans 307 stored in the relational database 302 or in one or more other databases (not shown in FIG. 3), project templates 311-314 are generated for each of the locations. The project templates 311-314 include the tasks to be performed for each of the locations involved in the project, Project I 211. The tasks included in the project templates 311-314 are similar to the tasks previously described with reference to the system 200 of FIG. 2, such as resource scheduling 221, pre-visit activities 222, on-site activities 223, and completion activities 224.

By contrast to the tasks 221-224, however, the tasks associated with each of the project templates 311-314 may include reference information to clearly associate them with respective implementations and locations. For example, the resource scheduling 321 included in the first project template 311 may be labeled as “Task A-1” to clearly associate the resource scheduling with the implementation at Location A 120. It may be important to plainly associate the tasks in the project templates 311-314 to the respective locations where they are to be implemented because the tasks may be concentrated with other, similar tasks for a number of different locations and assigned to task administrators specializing in executing those particular tasks.

For example, the resource scheduling for Locations A-N 321-324 are all concentrated under a first task administrator 316. The first task administrator 316 is not charged with responsibility for each of the series of tasks associated with a particular location as the project managers 215-218 of the system 200 of FIG. 2 were charged with the series of tasks associated with particular locations. Instead, the first task administrator 316 is charged with repeatedly performing the similar tasks of resource scheduling 321-324 across each of the implementations at Locations A-N 220-280. The resource scheduling 321-324 is performed by the first task administrator 316 according to information provided from the server 301 and the relational database 302. The project manager 315, by contrast with the system 200 of FIG. 2, may only become involved in the resource scheduling tasks 321-224 if an exception should arise, for example, if no providers with the desired credentials are available at the desired date and time to do the work.

Depending on the number and complexity of tasks, a task administrator may be trained for and assigned to administering more than one set of similar tasks. As shown in FIG. 3, for example, the first task administrator 316 may be tasked both with performing resource scheduling 321-324 for Locations A-N 220-280 and with managing pre-visit activities 331-334 for Locations A-N 220-280. On the other hand, one or more task administrators may be assigned to administering a single set of tasks. For example, the second task administrator 317 may be tasked only with on-site activities 341-344 and the third task administrator 318 may be tasked only with completion activities 351-354. Although not shown in FIG. 3, multiple task administrators may be assigned to administering a single set of tasks.

In sum, embodiments of the present disclosure leverage information technology to translate standards 303, templates 304, and information on providers 305, coupled with client requirements 306 and project plans for the client 307 to generate project templates 311-314 that include tasks for each of the implementations of a project. For example, the project templates 311 for Location A 220 includes tasks for administering resource scheduling 321, pre-visit activities 331, on-site activities 341, and completion activities 351. Each of the tasks 321, 331, 341, and 351 in the project template 311 for Location A 220 is similar to like tasks for other project templates, such as the tasks for administering resource scheduling 322, pre-visit activities 332, on-site activities 342, and completion activities 352 in the project template 312 for Location B 230. Thus, like tasks may be collected and assigned to a task administrator trained in administering a particular task instead of assigning a highly skilled project manager the task of performing each of the different tasks. For example, the first task administrator 316 may be assigned with the tasks of resource scheduling 321-324 across the project templates 311-314 for Location A 220 through Location N 280, the second task administrator 317 may be assigned with the tasks of administering on-site activities 341-344 across the project templates 311-314 for Location A 220 through Location N 280, etc. The project manager 315 then may be freed for exception management or other high level tasks. The positions of the task administrators 316-318 may be staffed with less costly personnel at remote, rural, or international locations at the call center 319.

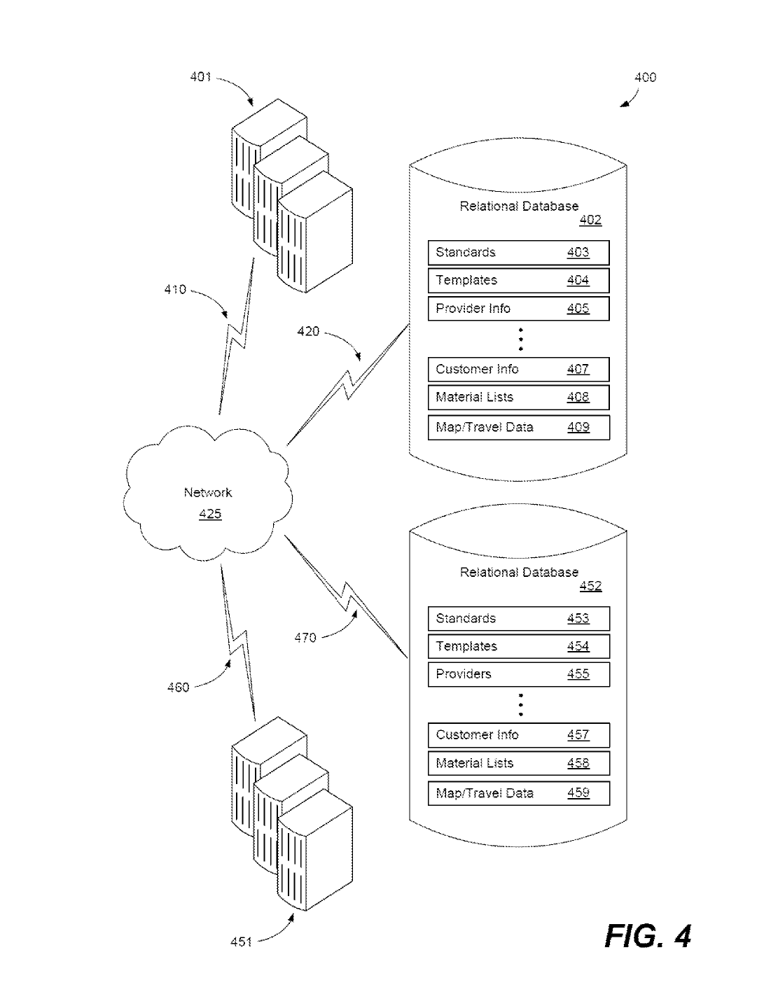

FIG. 4 is a block diagram of a computer system 400 that may be utilized in implementing an embodiment of a process of templification and concentration of tasks according to the present disclosure. In a particular embodiment, it may be desirable to operate one or more servers/server farms 401 and 451 to provide processing bandwidth to support project implementation. Maintaining multiple servers/server farms 401 and 451 may also provide desirable redundancy or fault tolerance in the event of failure of one of the servers/server farms 401 and 451. It may be desirable to maintain the servers/server farms 401 and 451 at separate locations to maintain operation of the overall system 400 in the event that a power failure or other unforeseen circumstance at one location should cause one of the servers/server farms 401 and 451 to fail.

Correspondingly, the computer system 400 may include multiple physical relational databases 402 and 452. The databases 402 and 452 may store separate sets of data that are accessible to each of the servers/server farms 401 and 451, or the databases 402 and 452 may be identical databases to support fault tolerant operations if one of the databases 402 and 452 should fail, become inaccessible, etc.

The servers/server farms 401 and 451 and databases 402 and 452 may communicate via a network 425, which may include a public network, a private network, a virtual private network, and/or another network medium providing desirable communication bandwidth. The servers/server farms 401 and 451 and databases 402 and 452 may each be interconnected with the network 425 via communications channels 410, 420, 460, and 470, respectively. The network 425 and the channels 410, 420, 460, and 470 may include one or more of wired communications links, wireless communications links (including radio frequency communications, optical communications, or microwave communications), or other suitable communications media.

With regard to FIG. 4, it is also noted that the databases 402 and 452 may include many types of information in addition to the types of information described with regard to the example of FIG. 3. For example, the database 402 may include information on standards 403, templates 404, provider information 405, client or customer information 407, material lists 408 for various types of projects, map and travel data 409 for use in project planning and scheduling, and other types of information. The database 452 may also maintain information on standards 453, templates 454, provider information 455, client or customer information 457, material lists 458, map and travel data 459 which may be different than the information stored in the database 402 or may be a duplicate copy of the information stored in the database 452. As previously described with reference to FIG. 3 and as further described below, the information stored in the databases 402 and 452 is used to leverage computer and communications systems to make implementation of a project more efficient by enabling the computer system 400 to perform or facilitate redundant or repetitive tasks, handle communications with providers, and to facilitate provider selection and scheduling.

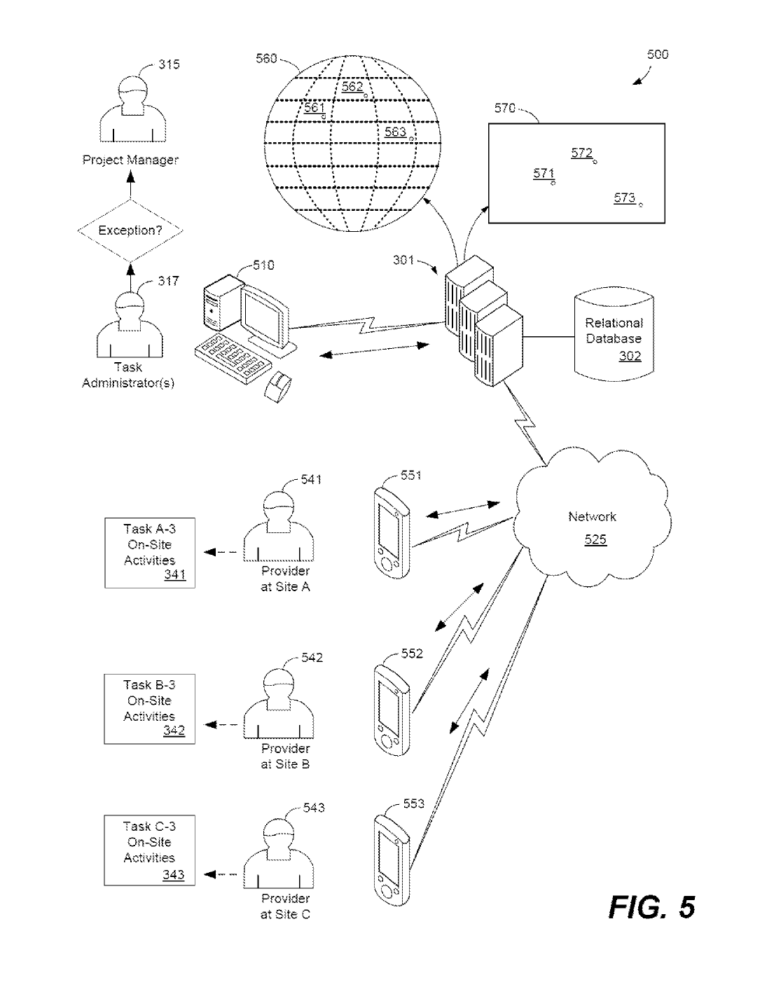

FIG. 5 illustrates a system 500 in which information and communications technology may be utilized to make more efficient use of task administrator resources, as well as project manager resources. As in the example of the system 300 of FIG. 3, the server 301 coupled with a relational database 302 is accessed by the task administrators, such as the second task administrator 317, via a workstation 510 coupled to the server 301. In the example of the system 300 of FIG. 3, the second task manager 317 was charged with administering the on-site activities 341-343 at Locations A 220, B 230, and C 240, and potentially other locations. As shown in FIG. 5, completion of the on-site activities 541-543 may be vested in providers 541-543 at the different locations (who may have been engaged by one or more other task administrators as part of the resource scheduling tasks 321-344, as described with reference to FIG. 3).

To facilitate management of the providers 541-543, each of the providers may possess or may be provided with a portable communications device, such as “smart phones” or other handheld wireless devices 551-553, that are used at the implementation locations. Through a network 525, the server 301 may be able to communicate with the handheld wireless devices 551-553. As a result, instead of the second task administrator 317 individually telephoning, paging, messaging, or otherwise contacting each of the providers 541-543, for example, to confirm arrival at respective implementation locations, the server 301 may generate and send such messages based on the data stored in the relational database 302. The relational database 302 may store contact information for each of the providers 541-543, scheduled arrival information for each of the tasks 341-343, and other pertinent information. Using this information, the server 301 may automatically generate communications to the providers 541-543.

Similarly, the server 301 may monitor responses to the communications. The server 301 may track whether each of the providers 541-543 has responded in the affirmative, in the negative, or has failed to respond. Upon checking this information, if one of the providers 541-543 did not arrive on time or has failed to respond, the second task administrator 317 then may attempt to contact those providers to determine whether the provider is on site but has failed to respond to the message, is en route, or is experiencing difficulties such that the provider will be unable to perform assigned tasks. In the latter cases, a provider who is running substantially late or who may be unable to appear at all may become exceptions to the project plan. In the case of exceptions, the server 301 or the second task administrator 317 may contact or otherwise alert the project manager 315, who may then try to correct or adapt for the exception.

Use of the handheld wireless devices 551-553 or other portable communications devices may serve additional purposes. For example, some smart phones or similar communications devices incorporate global positioning system (GPS) technology so that they may automatically report their present location at intervals or in response to a position query. Using this technology, the server 301 and, thus, the task administrators or project managers may be able to monitor geographical locations 561-563 of the providers 541-543 over a geographical area 560 or even measure their local positions 571-573 within a facility or other local site 570. As a result, the system may estimate the estimated arrival time or further generate re-routing instructions to different events or tasks as needed necessary.

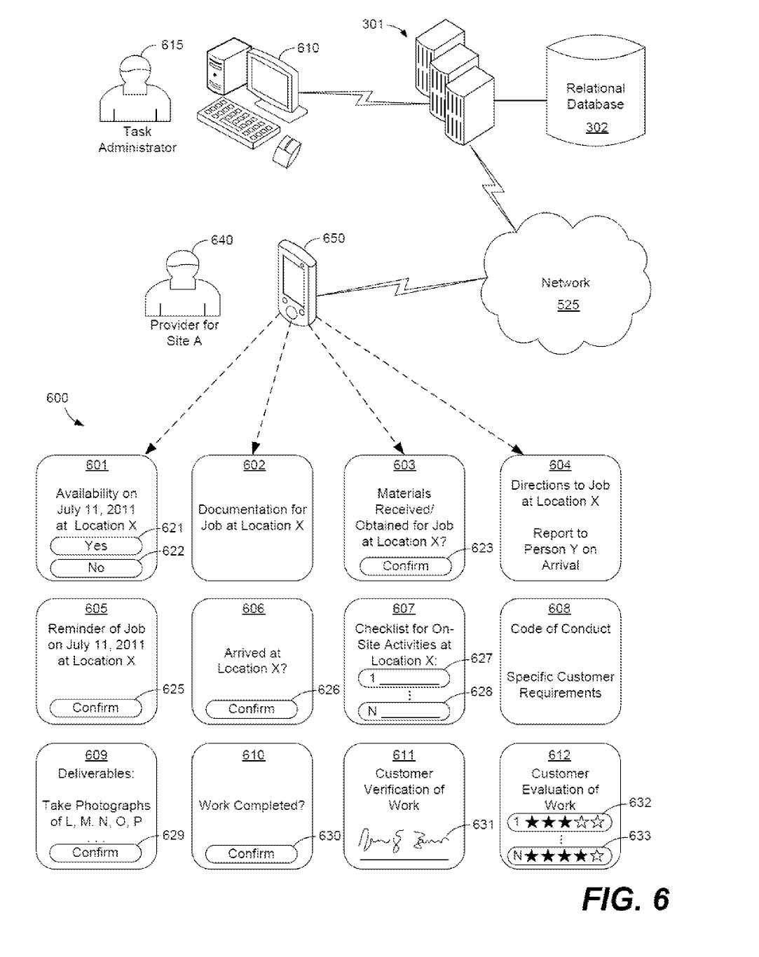

FIG. 6 illustrates a plurality of communications 600 that may be transmitted between a task administrator 615, and a provider 640 via one of the handheld wireless devices 650. The communications 600 may include a plurality of electronic request transmissions sent to providers, such as the provider 640. The electronic request transmissions may elicit a plurality of electronic responses that then are reviewed by the computer systems. The plurality of communications 600 includes examples of communications that may be sent between the server 301 and the provider 640 via the network 525, between the task administrator 615 and the provider 640, or between a project manager (not shown in FIG. 6) and the provider 640. The plurality of communications 600 is exemplary in nature, and should not be taken as an exhaustive or limiting list of all the communications that may pass between the participants.

For example, as part of a resource scheduling task, such as the resource scheduling task 321 of FIG. 3, an electronic request transmission in the form of an availability message 601 inquiring whether the recipient is available to staff a project on a particular day or on a particular day and at a particular time. The availability message 601, like other communications 600, may include text messages, e-mail, automated voice communications, or other forms of communication. The availability message 601, like others of the plurality of electronic request transmissions or other communications 600, may request a response. The response may be electronically sent by selection of a “yes” field 621 or a “no” field 622, or by selection of some other button or response field. A response also may be requested by e-mail, text message, voice telephone communications, image or video transmissions (e.g., to provide completion of a task) or another form of communication.

The availability message 601 may be automatically generated and sent by the server 301 based on having identified a particular provider from the provider information stored in the relational database 302 (such as the provider information 405 or 455 stored in relational databases 402 or 452, as described with reference to FIG. 4, and as further described below). Alternatively, the availability message 601 may be generated by an appropriate task administrator 615 using a workstation 610 coupled to the server 301. The task administrator 615 may generate the availability message 601 from a shell message or template stored at or generated by the server 301. Alternatively, the task administrator 615 may generate the availability message as a text message, an e-mail message, or place a telephone call to the provider 640 in response to a task template being generated by the server 301 based on information stored in the relational database 302 for the project.

A message forwarding necessary documentation 602, such as instructions, site plans, specifications, or other information may be sent to the provider 640. A materials confirmation message 603 may to inquire whether materials to be used in an implementation has been received or procured by the provider. The materials confirmation message 603 may request confirmation of receipt by selection of a “confirm” field 623 or by another type of response such as previously described with reference to the availability message 601. An instructional message 604 providing directions as to how to reach the location where the provider 640 is to appear or instructions as to whom to contact upon arrival may be sent to the provider.

In advance of the on-site activities, a reminder 605 of the provider's commitment to appear may be sent to the provider. The reminder 605 may request confirmation that the provider 640 will appear at the appointed time and location by selecting a “confirm” field 625 or by another type of response. At or about the scheduled commencement of the on-site activities, an arrival confirmation message 606 may be sent to the provider 640. The arrival confirmation message 606 also may request confirmation that the provider 640 has arrived at the appointed location by selecting a “confirm” field 626 or by another type of response.

Before or around the time when the on-site activities are scheduled to commence, a checklist message 607 may be sent. The checklist message 607 may include a number of milestone fields, such as fields 627 and 628. The provider 640 may be asked to select corresponding milestone fields upon completion of an associated milestone activity or to initiate some other communication to signal reaching each milestone. For example, if the project involves installation of new telecommunications or point of sale equipment, the milestones may include disconnection of old equipment, installation of appropriate wiring or wiring harnesses, installation of new hardware, installation of software, testing, client acceptance, or other activities.

The plurality of communications 600 may include a code of conduct message 608. The code of conduct message 608, for example, may remind the provider 640 of specific customer requirements about how the on-site activities are to be conducted, rules that the provider 640 should observe while on site, or similar rules. The plurality of communications 600 also may include a deliverables message 609 that specifies information the provider 640 must supply to demonstrate completion of the on-site activities. The deliverables may be based on standard of the project management organization or may be based on requirements presented by the client. For example, the provider 640 may be required to take photographs of a number of aspects of the purportedly completed installation or to take photographs from a number of angles to permit remote verification that the installation is completed. The handheld wireless device 650 may include a camera, as so many smart phones or other handheld wireless devices do, to facilitate capture and collection of the photographs by the server 301 or the task administrator 615. Once the deliverables have been created or collected, the provider 640 may select a “confirm” field 629, transmit electronic deliverables, or send another type of response.

In response to the provider 640 checking off the milestones 627 and 628 in the checklist message 607, in response to providing deliverables requested in the deliverables message 609, or another event, the provider 640 may receive a completion confirmation message 610. The confirmation message 610 may request that the provider 640 select a “confirm” field 630 or initiate some other type of communication to attest that the work is completed. In response to the provider 640 asserting that the work is completed, a customer verification message 611 may be sent that necessitates the provider 640 obtaining a customer signature 631 or other customer verification that the work is completed. Similarly, customer evaluation message 612 may be generated that includes response fields 632 and 633 that request that the customer representative rate the work, conduct, or other behavior of the provider 640.

As the plurality of communications 600 may be automatically generated or facilitated by the server 201, the responses sent by the provider 640 or a customer (not shown in FIG. 6) may be automatically tabulated by the server 301. Alternatively, the responses may result in messages the task administrator 615 may manually process to determine whether any exceptions have occurred that may necessitate further actions by the task administrator 615 or the project manager (not shown in FIG. 6). The task administrator 615 may then update the relational database 302 or otherwise report to the project manager (not shown in FIG. 6) of the progress of tasks.

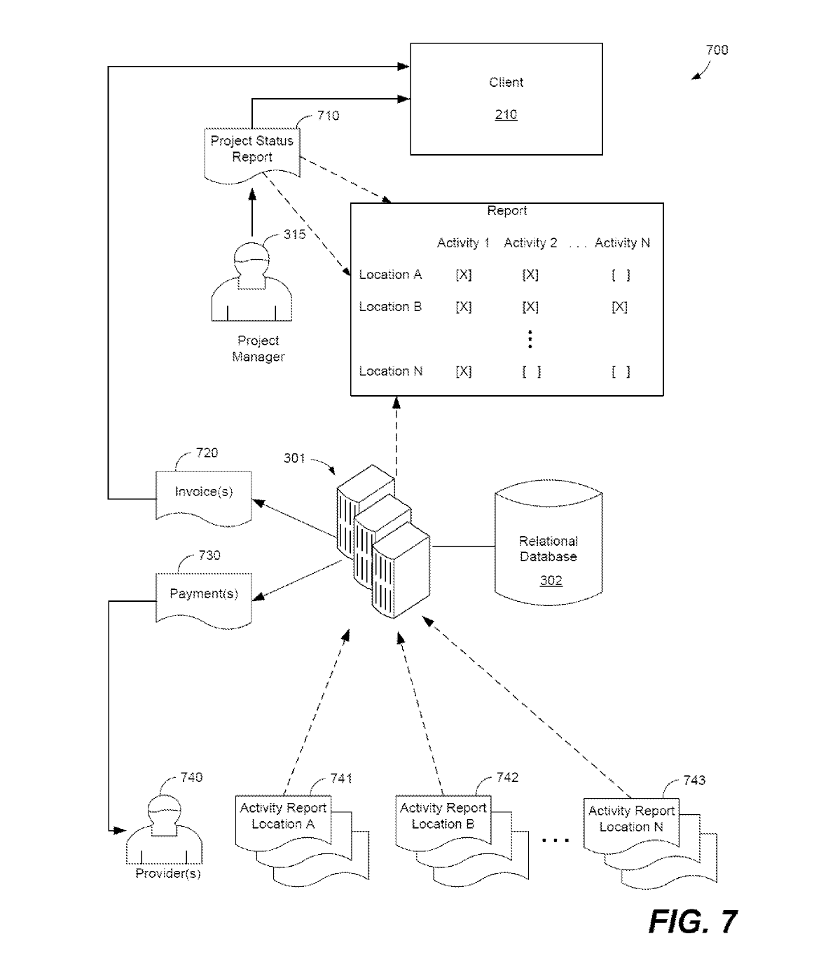

FIG. 7 illustrates a system 700 depicting how the communications coordinated via the server 301 and the relational database 302 facilitate reporting, invoicing, and payments to enable the project manager 315 to focus on exception management (not shown in FIG. 7). As previously described with reference to FIG. 6, the server 301 is used to communicate with the providers 640 to coordinate and monitor the activities of the one or more providers 640. The communications between the one or more providers 740 and the server 301 may constitute a plurality of activity reports 741-743 that are sent from the one or more providers 740 from each of the locations to the server 201. Information received via the activity reports 741-743 may be stored in the relational database 302 and tabulated at the server 301 to generate one or more project status reports 710.

The project status reports 710 may indicate the completion status of each of the activities to be performed for each of the implementations or locations involved in the project. In a particular embodiment, the information in the project status reports 710 may be automatically tabulated and presented by the server to the project manager 315 based on the activity reports 741-743. Alternatively, the information may be collected or validated by task administrators (not shown in FIG. 7) and then collected at the server 301 for presentation to the project manager 315.

The project manager 315 may use the project status reports 710 to identify exceptions where activities are not being completed, are not being completed on time, are not being accepted by client representatives, etc. Thus, the project status reports 710 may be used by the project manager 315 to identify those activities with which the project manager should consult with appropriate task administrators or providers to resolve problems. Also, the project status reports 710 may be used by the project manager 315 to provide updates to the client 210 on the status of the project. The project status reports 710 may be used to provide regular updates to the client 210 or may be used by the project manager 315 to respond to ad hoc queries from the client as to the status of the project generally or as to the status of the project at particular locations.

In addition, the data gathered at the server 301 may be used to automate or facilitate the generation of invoices 720 and payments 730. For example, an agreement between the client 210 and the project management organization provides for milestone payments as particular activities are completed or as implementations at one or more locations have been completed. Based on activity reports 741-743 collected at the relational database 302, the server 301 may identify when billing milestones have been reached and, in response, generate the appropriate invoices 720 for presentation to the client. Correspondingly, an agreement between the project management organization and the providers 740 may provide for payment to the providers 740 upon completion of particular activities or upon completion of all activities at particular locations. Thus, based on information in activity reports 741-743 collected at the relational database 302, the server 301 may identify when payment is due to the providers 740 and generate the payments 730 as appropriate.

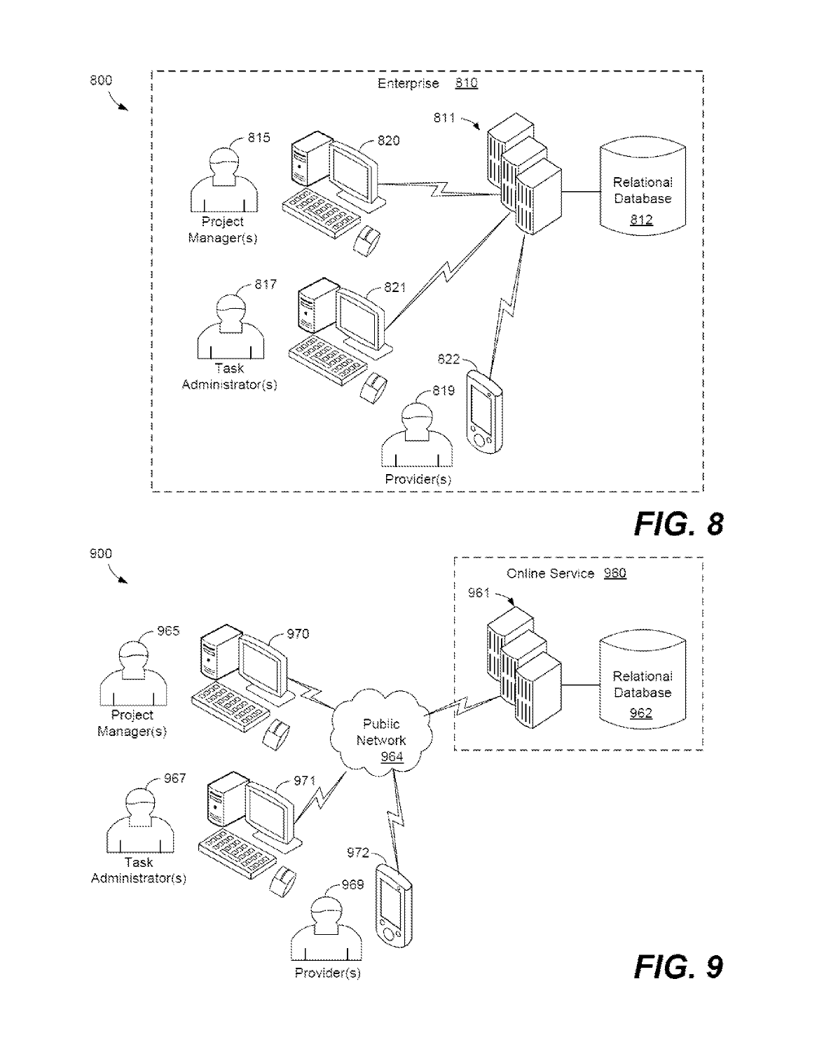

FIGS. 8 and 9 illustrate alternative implementations of information resources to support methods of the present disclosure. As previously described with reference to FIGS. 3, 6, and 7, for example, coordination of providers to manage projects may be performed by one or more project managers 315, task administrators 316-318, and/or providers (not shown in FIG. 3) that are not part of the client 210 organization. Methods of the present disclosure may be performed by third parties to the client using, for example, a server 301 and relational database 302 that are maintained and operated by a project management organization. However, methods of the present disclosure may be applied for use within an enterprise or such methods may be implemented by parties using information resources provided by a third party as further described below. The information resources may be managed by computer-executable instructions stored on a non-transitory computer readable media accessible and executable by computing systems making up a portion of the information resources. The computer-executable instructions thus manifest methods of generating tasks and coordinating execution of those tasks in various environments.

For example, in a system 800, an enterprise 810 may be a manufacturer, retailer, service provider or other organization that employs or retains one or more project managers 815, task administrators 817, and providers 819 to manage, administer, and service its own projects. Even for projects planned and performed solely within the enterprise 810, the disclosed methods may be used to efficiently manage the project by reducing the number of project managers 815 involved in a particular project by relying on task administrators 817. Information resources, such as a server 811 and a relational database 812 may be used to generate project templates based on enterprise standards, templates, and information about enterprise providers stored in the relational database 812. The project managers 815, task administrators 817, and providers 819 may use fixed or portable workstations or devices 820-822 coordinated through the server 811 to facilitate task assignments and monitoring, all as previously described with reference to FIGS. 3-7. Alternatively, some combination of internal and external staffing of positions of project managers 815, task administrators 817, and providers 819 may be used under the coordination of the server 811 and 812. In any case, computer-executable instructions accessible and executable by the server 811 within the enterprise 810 may generate tasks and coordinate execution of the tasks for the enterprise 810.

In another system 900 illustrated in FIG. 9, some or all of one or more project managers 965, task administrators 967, and providers 969 may be separate contractors or entities that have joined together to implement a particular project. To support implementation of the project, the project managers, for example, the one or more project managers 965 may subscribe to or contract with an online service 960 that maintains a server 961 and a relational database 962 executing computer-executable instructions that embody the methods of the present disclosure. The online service 960 may provide information through public network 964 to the one or more project managers 965 about the task administrators 967 or providers 969 that lead the one or more project managers 965 to engage those parties in the implementation of the project. The online service 960 then may be employed by the one or more project managers 965, task administrators 967, and providers 969 using fixed or portable workstations or devices 970-972 to generate tasks, communicate about performance of tasks, generate reports, generate invoices and bills, and otherwise support the efforts of the one or project managers 965-967.

Alternatively, an enterprise may retain the one or more project managers 965, task administrators 967, and providers 969, but may desire to retain the online service 960 to coordinate the generation of tasks and monitor performance of the tasks. As in the example of the system 900, the online service 960 may maintain the server 961 and the relational database 962 executing computer-executable instructions that embody the methods of the present disclosure to support implementation of the project.

In sum, the methods of the present disclosure may be implemented in a variety of ways. Just for example, the methods may be provided as part of a project management service contracted by an enterprise, as previously described with reference to FIGS. 3-9. The methods may be embodied in computer-executable instructions stored on a non-transitory tangible medium that may be acquired and used within an enterprise, as described with reference to the system 800 of FIG. 8. Also, the methods may be embodied in computer-executable instructions stored on a non-transitory tangible medium operated by an online service, as described with reference to the system 900 of FIG. 9.

A beneficial aspect of the previously described embodiments is the manner in which providers may be identified to perform particular aspects of projects. As described with reference to FIG. 3, the relational database 302 may maintain information regarding providers (such as information 405 and 455 as described with reference to the databases 402 and 452, respectively, of FIG. 4) who are available to perform particular activities. The information on providers thereby may assist the project manager 315 or the task administrators 316-318 in identifying providers to perform particular activities. Alternatively, as also previously described, the information on providers stored in the relational database 302 may support automatic selection of providers or based on identified needs or objectives of the project.

Referring to FIG. 10, according to a disclosed embodiment, a map 1000 shows a project location 1010 to be staffed. Potential providers in a mapped area, which may include localities, states, countries, regions, or the world 1002, each are associated with location information. The potential providers may be associated with locations defined by longitude 1004 and latitude 1006. Identifying potential providers by longitude 1004 and latitude 1006 has the advantage of being a coordinate system that is applicable across the entire world. Potential providers also may be associated with one or more defined zones 1008. A defined zone, for example, may include a county, a state, a region, a telephone area code, or a postal ZIP code.

Once the project location 1010 is specified, information on potential providers is accessed. The information may be presented graphically, such as in an enlarged map of the adjacent area 1011 to the project location 1010. The provider information may indicate the specific location of each of a number of potential providers. The providers may be apportioned into zones 1021-1023 based on proximity to the project location 1010. For example, the zones 1021-1023 may separate the providers according to a linear or road mileage distance from a listed address of the provider to the project location. Alternatively, the zones 1021-1023 may be delineated based on other information, such as estimated or solicited data regarding travel costs attributable to working at the project location 1010. For example, providers in zone 1 1021 may be providers that are sufficiently close to the project location 1010 that there are no travel charges for work at the project location 1010. Alternatively, the providers in zone 1 1021 may include providers that have indicated they will not bill for travel costs to the project location 1010 irrespective of distance to the project location 1010. Zone 2 1022 may include providers for which some first measure of travels costs may be anticipated or allowed, while zone 3 1023 may include providers 1030 for whom a higher measure of travel costs may be anticipated or allowed.

Proximity to the job location 1010 or generalized travel costs to the job location 1010 may constitute only a portion of the provider information that may be maintained. Information about the rates or specific travel costs charged by providers may be included. Experience of the provider or customer satisfaction with the provider also may be included. These types of information are provided for example and are not intended as an exhaustive list. The provider information maintained may include any number of pieces of objective or subject information about particular providers.

The rates or travel costs maintained for the providers may include actual hourly costs or some relative indicia of cost. For example, provider information 1041 maintained for a first provider 1031 in zone 2 1022 indicates a cost of “120,” which may be an hourly rate or an indexed rate relative to a reference rate equated 100 (e.g., an index rate of “140” may indicate that the provider 1031 charges forty percent more than a selected reference rate). The provider information 1041 for the first provider 1031 may include a travel charge of 25 that may represent a flat charge, a number of chargeable miles to the project location 1010, or some other indicator of absolute or relative travel costs. By comparison, provider information 1042 maintained for a second provider 1032 in zone 1 1021 may indicate a cost of “140” and travel charge of “0.” Thus, a project management organization can readily compare prices with or without including travel costs that may skew the actual job cost.

Information about the providers may also include information about the experience of each of the providers. The indicia of experience may represent historical data as to the number of times the provider has rendered a particular service or the number of times the provider has rendered the particular service for the project management organization maintaining the provider information 1041. For example, the provider information 1041 for the first provider 1031 may be “37,” indicating that the first provider has documented performing a particular service 37 times or has performed the particular service 37 times on behalf of the project management organization maintaining the provider information 1041. The provider information 1041 for the second provider 1032 may be “8,” indicating that the second provider 1032 has documented performing a particular service eight times or has performed the particular service eight times on behalf of the project management organization maintaining the provider information 1042. The relative experience of the providers 1031 and 1041 thus may be considered in selecting a provider.

The specificity of the information on experience may be as specific or as granular as decided. For example, the information stored may include the experience the provider has in performing a particular task in a particular type of industry (e.g., such as banking, health services, etc.) or location (e.g., retail, office, etc.). The information on experience may also be specific with an exact type of equipment or model of device being installed. Thus, as desired, the project management information may be able to identify providers that have experience in installing, upgrading, or otherwise working with a particular class, brand, or model of device in a particular type of industry and in a particular type of location, to ensure that appropriately skilled providers are selected for particular tasks. Such specific experience may be chosen by the project management personnel, or may be demanded by the client.

In addition, the provider information 1041 may include a satisfaction rating. For example, a satisfaction rating of “4.6” in the provider information 1041 for the first provider 1031 may be an average score on a known scale based on work performed for all reporting customers or just based on work performed for the project management organization maintaining the provider information 1041. Correspondingly, a satisfaction rating of “4.5” in the provider information 1042 for the first provider 1032 also may be an average score for all reporting customers or just based on work performed for the project management organization maintaining the provider information 1042. Thus, quality ratings also may be considered in selecting a provider.

As previously stated, the information included in the provider information 1041 and 1042 of FIG. 10 is intended exemplary in nature and should not be taken as limiting. Other information, such as contact information, certifications held, number of qualified personnel, or other information also may be included in the provider information 1041 and 1042 and used in selection of providers. In addition, the information may be updated by contemporaneously-obtained information, such as availability for a project on a particular date. For example, as described with reference to FIG. 6, a server (not shown in FIG. 10) may use stored contact information to automatically transmit an availability message 601 to the providers 1031 and 1041 or provide the information to task administrators to contact the providers 1031 and 1041 by telephone or another communications medium to determine their availability on one or more particular dates. The information obtained may be automatically or manually entered into the provider information 1032 and 1042 to assist in selection of one or more providers for a particular project.

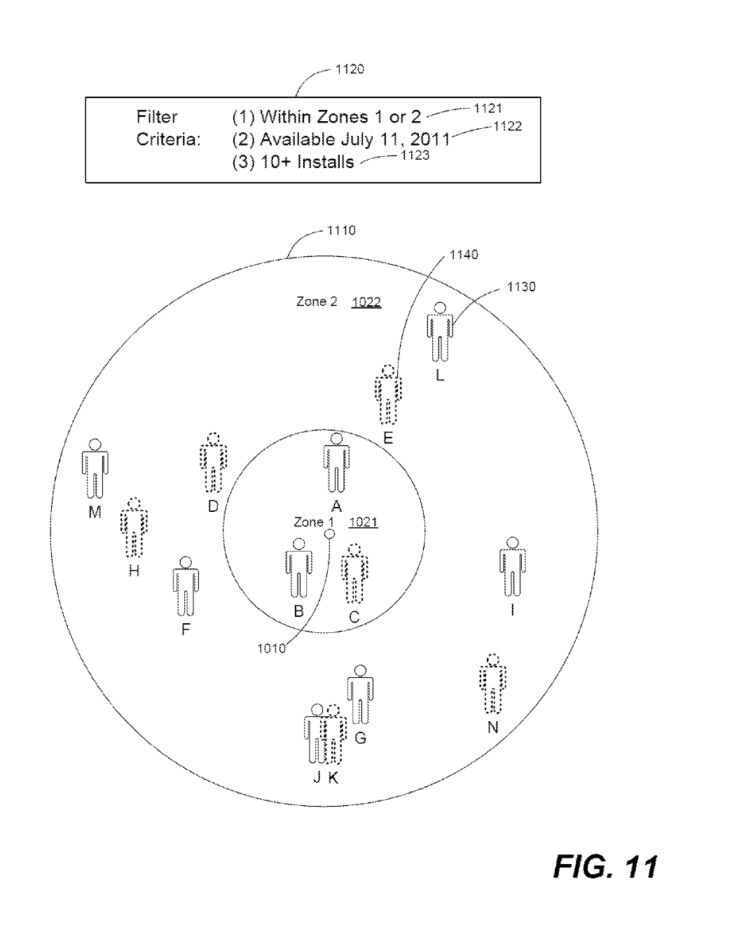

FIG. 11 illustrates an example of how the provider information maintained for a plurality of providers may be used to filter information about known providers to a list of providers suitable for a particular project. The filtered information on providers is shown in FIG. 11 in map form for the sake of illustration, but it should be understood that such information may actually be generated in map form, list form, or in any other desired form for use in implementing a project.

Filter criteria 1120 may be specified to identify which providers may be considered. Filter criteria may include one or more limiting criteria. For example, the filter criteria 1120 include three separate criteria 1121-1123. The first criterion 1121 is that potential providers will be within zone 1 1021 or zone 2 1022, for example, to limit travel costs, or to potentially improve response time or avoid possible performance delays resulting from long travel. The second criterion 1122 is that the providers be available on a particular date.

The third criterion 1123 is that the provider have performed ten or more installations, such as ten or more installations of a particular type, ten or more installations for the particular project manager, etc. As previously described, the information stored regarding providers' experience and, thus, the filter criteria that may be applied may be as specific or detailed as the project management organization cares to maintain and use. Applying the filter criteria 1120 yields a filtered list or map 1110 of potential providers to be considered. Based on the requirement that the potential providers be located in either zone 1 1021 or zone 2 1022, no providers in zone 3 1023 (FIG. 10) are included in the filtered map 1110. Based on unavailability or lack of experience, some providers, such as Provider E 1140, are eliminated from the filtered map 1110, as represented by Provider E 1140 being represented with a dotted outline to more plainly represent in FIG. 8 that providers in zone 1 1121 and zone 2 1122 have been filtered out from further consideration. Qualifying potential providers that meet all three filter criteria 1120 are shown with solid outlines, such as Provider L 1130.

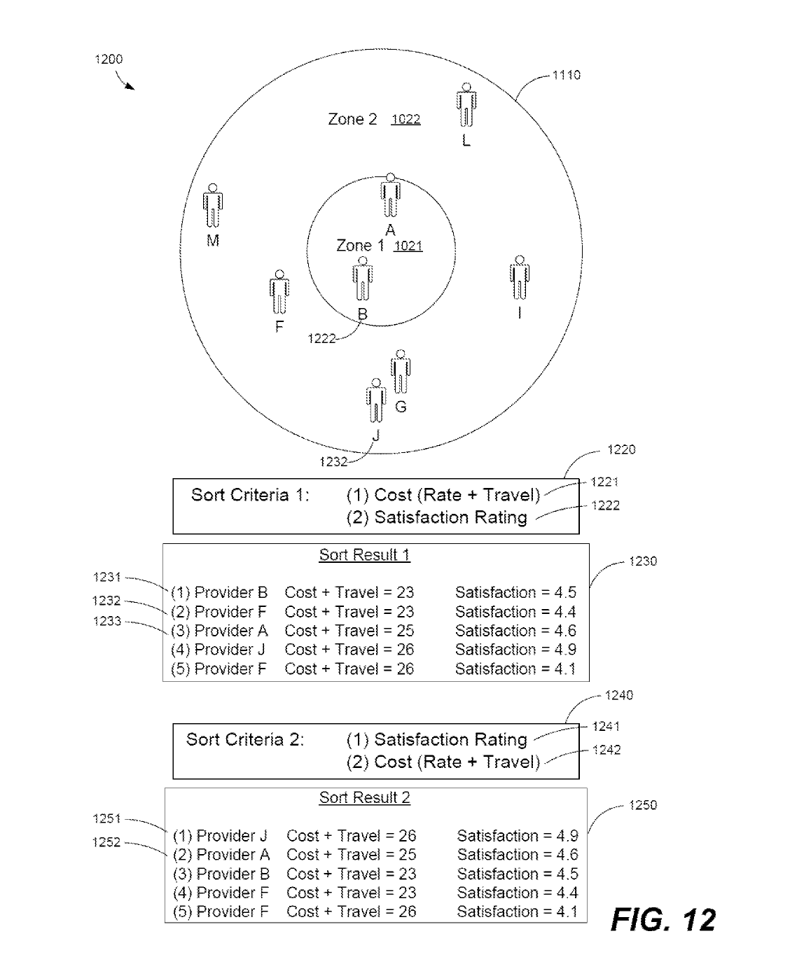

FIG. 12 illustrates an example of how the provider information maintained for a plurality of providers may be used to sort information about known providers to select one or more providers for a particular project. Potential providers may be sorted with or without prior filtering, as described with reference to FIG. 11. For the sake of example, the sorting described with reference to FIG. 12, map 1200, is based on the filtered map 1110 of FIG. 11, although previous filtering may not have changed the sorted lists of providers 1230 and 1250 presented in FIG. 12.

Similar to the filter criteria 1120 specified with reference to FIG. 11, sort criteria may be selected and entered by a project manager, task administrator, or other user. The filter criteria or the sort criteria also may be derived from the standard information, client requirements, or other data known or created about the project. Two different sets of sort criteria 1220 and 1240 are applied leading to two different sets of sort results 1230 and 1250. The application of the two different sets of sort criteria 1220 and 1240 are provided for illustration of how selection of different criteria leads to different results. The application of two different sets of sort criteria 1220 and 1240 also may illustrate a process followed by a project administrator or task administrator if, for some reason, application of the first set of sort criteria 1220 results in the first sorted list of providers 1230 not being acceptable. For example, sorting first by cost may result in a list of providers, of whom the highest ranked providers have relatively low experience or satisfaction ratings. Such results may lead the project manager or task administrator to initiate a second sort of the potential providers.

The first sort criteria 1220 includes a primary sort criterion 1221 than ranks potential providers based on cost, including both rate and travel costs. A secondary sort criterion 1222 ranks potential providers based on satisfaction rating, such as previously described with reference to FIG. 11. Applying the first sort criteria 1220 yields the first sorted list of providers 1230. A first listed provider, Provider B 1231, has the same total cost as Provider F 1232, thus, Provider B 1231 and Provider F 1232 are tied based on the first sort criterion 1221. However, application of the second sort criterion 1222 ranks Provider B 1231 ahead of Provider F 1232 by virtue of Provider B 1231 having a higher satisfaction rating. Both Provider B 1231 and Provider F 1232 outrank Provider A 1233. Although Provider A 1233 has a higher satisfaction ranking than either Provider B 1231 or Provider F 1232, the first sort criteria 1220 prioritizes cost 1221 over satisfaction ranking 1222.

The second sort criteria 1240 include a primary sort criterion 1241 than ranks potential providers based on satisfaction rating. A secondary sort criterion 1242 ranks potential providers based on cost, including both rate and travel costs. Applying the second sort criteria 1240 yields the second sorted list of providers 1250. A first listed provider, Provider J 1251, has the highest satisfaction rating of the potential providers; Provider A, 1252, is rated next. Application of the second sort criterion 1242 is not needed because the first ranked providers are not tied based on the first sort criterion as is the case with the first sort criteria 1220.

The examples of FIG. 12 show serially applied sort criteria. However, it should be appreciated that the sort criteria could be applied as evenly or unevenly weighted sort criteria. Further, more than two sort criteria may be included in each of the sorts.

Based on each of the sorted lists of providers 1230 and 1250, a provider may be automatically selected. For example, using the first sorted list of providers, Provider B 1231 may be automatically selected and sent a selection message by the server 301 (as described with reference to FIGS. 3 and 6). Alternatively, based on the results of applying the sort criteria, a project manager or task administrator may choose one of the potential providers based on the results of applying the sort criteria and other factors such as personal knowledge, recent customer satisfaction issues (that may or may not be reflected in the satisfaction rating maintained in the provider information), etc.

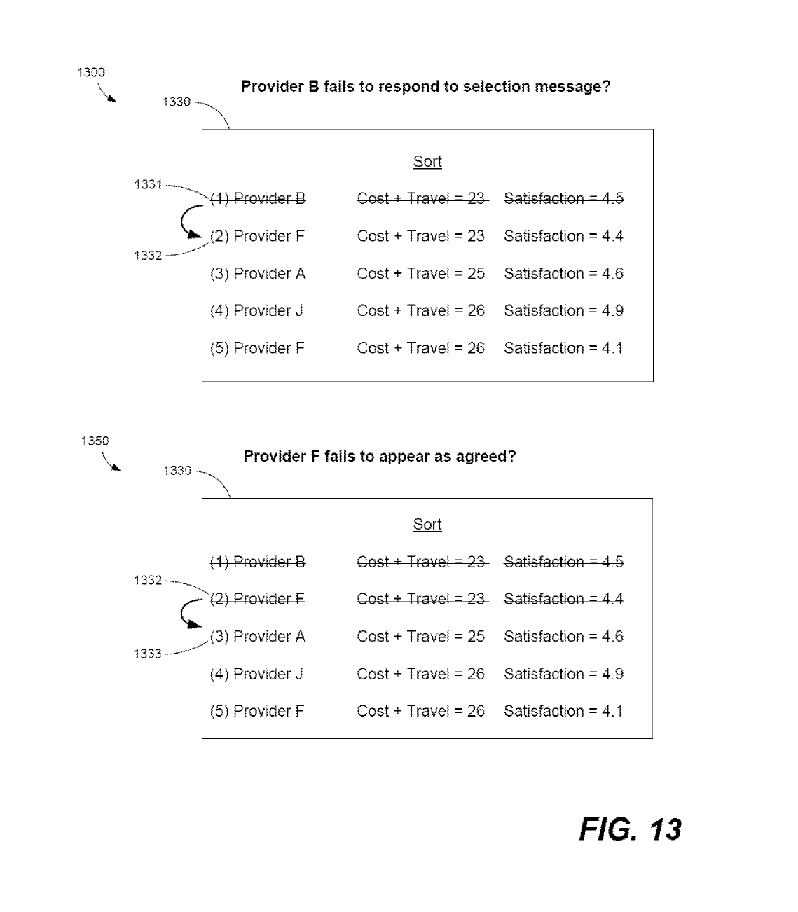

FIG. 13 illustrates how sorted lists of providers, such as the first sorted list of providers 1230 described with reference to FIG. 12, may be used to automatically or manually select or replace providers. FIG. 13 shows a first automatic replacement 1300 of a provider. For the sake of example, it is assumed that the first sorted list of providers 1330 (derived from the first sorted list of providers 1230 of FIG. 12, and based on the first sort criteria 1220), is used to select a provider. Based on the first sorted list of providers 1330, a selection message or call may be placed automatically or by a project manager or task administrator to Provider B 1331. However, Provider B 1331 may fail to respond to the offer in a timely fashion. The failure of Provider B 1331 to respond may constitute an exception.

As shown in FIG. 13, the failure of Provider B 1331 to respond to a selection message may constitute an exception that may be automatically corrected by dropping Provider B 1331 from the project and automatically sending an engagement message to Provider F 1332. Alternatively, if the replacement of a provider is not treated as being automatically correctable, a project manager or task administrator may manually correct the exception by engaging a next provided on the first sorted list of providers 1330. Automatically replacing the uncommunicative provider may save a project manager or task administrator the time of manually engaging a next provider. However, if the next provider is to be selected manually or contacted personally, the first sorted list of providers 1330 simplifies the task of the project manager or task administrator in selecting a next provider.

In a second automatic provider replacement 1350, Provider F 1332, for example, subsequently may fail to appear at the project location as agreed and, thus, fail to affirmatively respond to an electronic request transmission seeking to confirm the appearance of Provider F 1332 at the agreed upon location at the agreed upon time. Again, using the first sorted list of providers, a next provider, Provider A 1333 may be contacted automatically, to automatically correct the exception caused by Provider F 1332 failing to appear as agreed. Alternatively, replacement of a provider who does not appear may not be regarded as an automatically correctable exception, thus a project manager or task administrator may manually correct the exception by messaging or calling Provider A 1333 (and, possibly, contacting the client or customer to explain that a problem has occurred because of a provider's failure to fulfill an agreement, but that a replacement provider has been or is being secured). Again, even if such an exception is not designated for automatic correction, selecting Provider A 1333 to replace Provider F 1332 may quickly be done manually from the first sorted list of providers 1330.

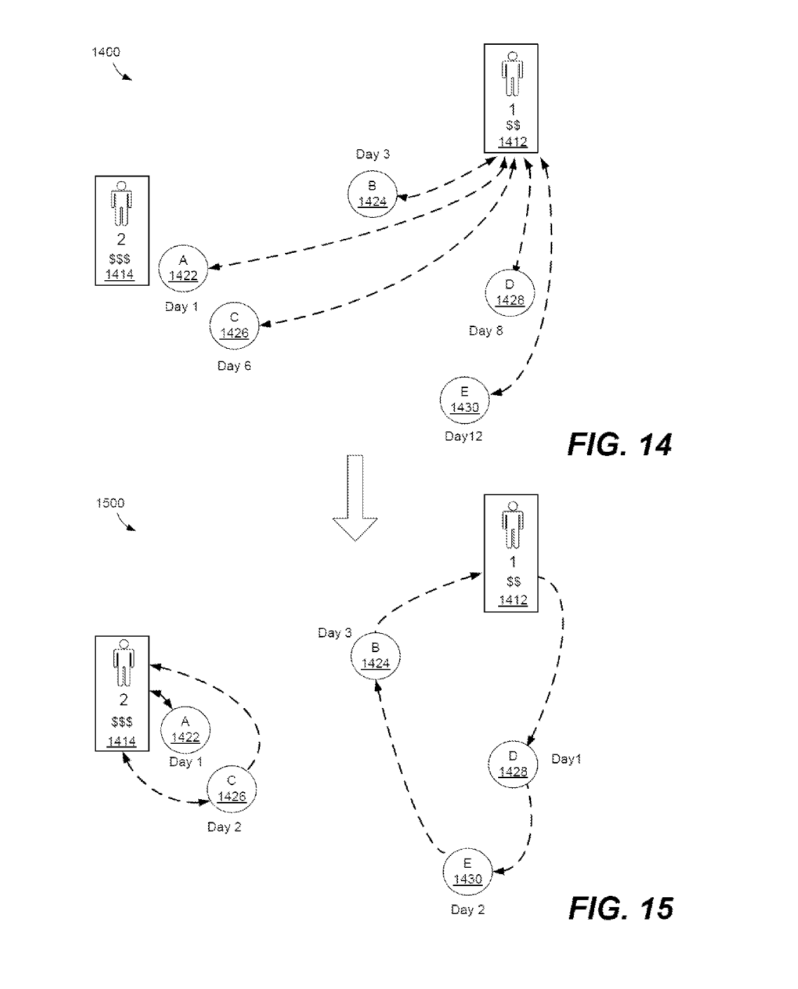

FIGS. 14 and 15 graphically represent how embodiments of the disclosure may be used to automatically generate a schedule or revise a schedule in order to serve one or more objectives identified for implementation of the project. For example, objectives identified by a client or project management personnel may include lowest cost, shortest implementation time, use of local providers (i.e., to support local businesses), use of most experienced providers, or any other number of factors. To that end, an initial schedule proposed by a client or by project management personnel may be generated or revised to better serve the one or more client objectives.

Referring to FIG. 14, an initial schedule 1400 may be generated according to a first objective of set of objectives for generating a schedule. FIG. 14 shows the schedule 1400 in a graphical, map-type form for the sake of explanation and illustration. However, it should be noted that the schedule also may be generated in list form, tabular form, or in any other format that may be desired.

The initial schedule 1400 shows that two providers, Provider 1 1412 and Provider 2 1414, have been identified to potentially provide goods or services for implementation of a project. As depicted by a number of “$” symbols associated with each of Provider 1 1412 and Provider 2 1414, Provider 1 1412 is the less costly of the two providers 1412 and 1414 (where the cost may include cost for materials or services, or such costs combined with shipping and/or travel costs to arrive at a total cost). If the objective in generating the schedule is lowest cost, Provider 1 1412 may be selected to provide the materials or services at each of locations A 1422, B 1424, C 1426, D 1428, and E 1430. Based on availability of the locations themselves or availability of Provider 1 1412 at or near each of the locations, a schedule may be generated at which Provider 1 1412 services Location A 1422 on Day 1 (relative to any appropriate calendar or temporal reference), services Location B 1424 on Day 3, Location C 1426 on Day 6, Location D 1428 on Day 8, and Location E 1430 on Day 12. Accordingly, over a period of 12 days, the lowest cost provider, Provider 1 1412, may service each of the locations to serve the implementation of implementing the project at a lowest cost.

The schedule 1400 of FIG. 14 may be automatically generated by a computing system based on available information regarding the client and the provider, such as dates available for implementation at each of the locations and provider availability, all of which may be requested by electronic request transmissions and addressed by electronic responses to the electronic request transmissions. Further, upon being provided with the objective of lowest implementation cost, the computer system may automatically select of Provider 1 1412 to service each of the locations.

By contrast, FIG. 15 shows a different schedule 1500 that may be initially generated or may be generated as a revised schedule if objectives for the implementation may include shortest implementation time, a combination of shortest implementation time and lowest cost, or some other combination of factors. The schedule 1500 shows the same locations, including Location A 1422, Location B 1424, Location C 1426, Location D 1428, and Location E 1430, and the same two providers, Provider 1 1412 (the lower cost provider) and Provider 2 1414. However, in contrast to the schedule 1400 of FIG. 14, the schedule 1500 shows that, based on the objective or additional objective of shortest implementation time, Provider 2 1414 is also used to enable implementation over a shorter time period.

As previously referenced, the schedule 1400 of FIG. 14 may have been initially proposed to the client or customer in order to provide a lowest cost implementation scenario. In response, the client or customer may then request a shorter implementation cycle that would call for the revised schedule 1500 of FIG. 15. Alternatively, if the client or customer initially requests a shorter implementation schedule, a schedule like the schedule 1500 may be an initially generated schedule. If, for some reason, the objectives for the implementation further change, additional factors may be taken into account and other schedules may be generated.

In the alternate or revised schedule 1500, the implementation cycle can be shortened from twelve days to three days by engaging both Provider 1 1412 and Provider 2 1414. Both Provider 1 1412 and Provider 2 1414 may work in parallel on Days 1 and 2, with Provider 1 1412 servicing Location D 1428 on Day 1 and Location E 1430 on Day 2 while Provider 2 1414 services Location A 1422 on Day 1 and Location C 1426 on Day 2. Provider 1 1412 then services Location B 1424 on Day 3 to finish the implementation for the specified locations. The implementation of schedule 1500 of FIG. 15 may be more costly, but is completed in a much shorter time (and also engages another, closer provider to Location A 1412 and Location C 1426, in case use of local providers is another stated objective to be used in the schedule).

Availability of Provider 1 1412 on different days than included in the schedule 1400 of FIG. 14 may be based on a response of Provider 1 1412 to the electronic request transmission sent to one or more providers identified as suitable. For example, if the original electronic request transmission to Provider 1 1412 open-endedly asked what days that Provider 1 1412 might be available over a widely specified timer period, Provider 1 1412 may have responded to indicate its availability on Days 1, 3, 6, 8, and 12 (as used in schedule 1400 of FIG. 14) based on its own convenience. By contrast, Provider 1 1412 may have tendered an electronic response to an electronic request transmission listing different dates if the electronic information request, for example, inquired as to when Provider 1 1412 was available in a three day window from Day 1 to Day 3 or a similarly shortened period. A computer system thus can generate one or more schedules to serve one or more stated objectives. In response to changes in provider availability or changes in objectives, the computer system may generate revised schedules. Further, task administrators or project managers (not shown in FIG. 14 or 15) may also manually revise the schedule as necessary in the event of scheduling exceptions or other reasons which potentially call for manual revision of a schedule.

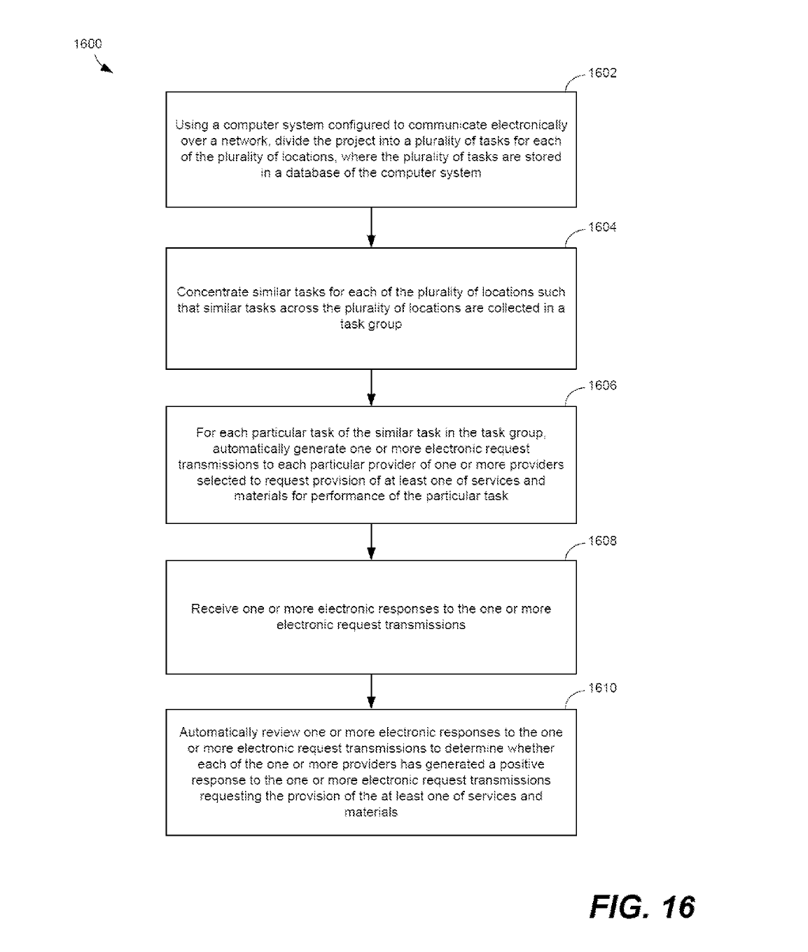

FIG. 16 is a flow diagram of a particular embodiment of a method 1600 of performing project management using task templification and concentration. Using a computer system configured to communicate electronically over a network, at 1602, the project is divided into a plurality of tasks for each of the plurality of locations where the project is to be implemented. As described with reference to FIGS. 3 and 5, for example, the plurality of tasks are stored in a database of the computer system.

At 1604, similar tasks for each of the plurality of locations are concentrated or assigned in a particular task group such that similar tasks across the plurality of locations are collected in a task group. Thus, for example, as described with reference to FIGS. 1, 3, and other figures, identifying providers capable of performing particular materials or services (and meeting whatever stated criteria may be used to identify suitable providers, such as described with reference to FIGS. 11-13) are assigned to one particular task group (which may be staffed by one or more task administrators and for which the identification of providers may be partially or entirely automated, as previously described).

At 1606, for each particular task of the similar task in the task group, one or more electronic request transmissions are automatically generated to each particular provider of one or more providers selected to request provision of at least one of services and materials for performance of the particular task, as described with reference to FIG. 6. At 1608, one or more electronic responses to the one or more electronic request transmissions are received, as also described with reference to FIG. 6. At 1610, one or more electronic responses to the one or more electronic request transmissions are automatically reviewed (such as by a computer system) to determine whether each of the one or more providers has generated a positive response to the one or more electronic request transmissions requesting the provision of the at least one of services and materials. Thus, computer systems may be used as described with reference to FIG. 6 and other figures to determine the availability of providers and to engage those providers through the exchange or electronic communications that are automatically reviewed by a computer system.

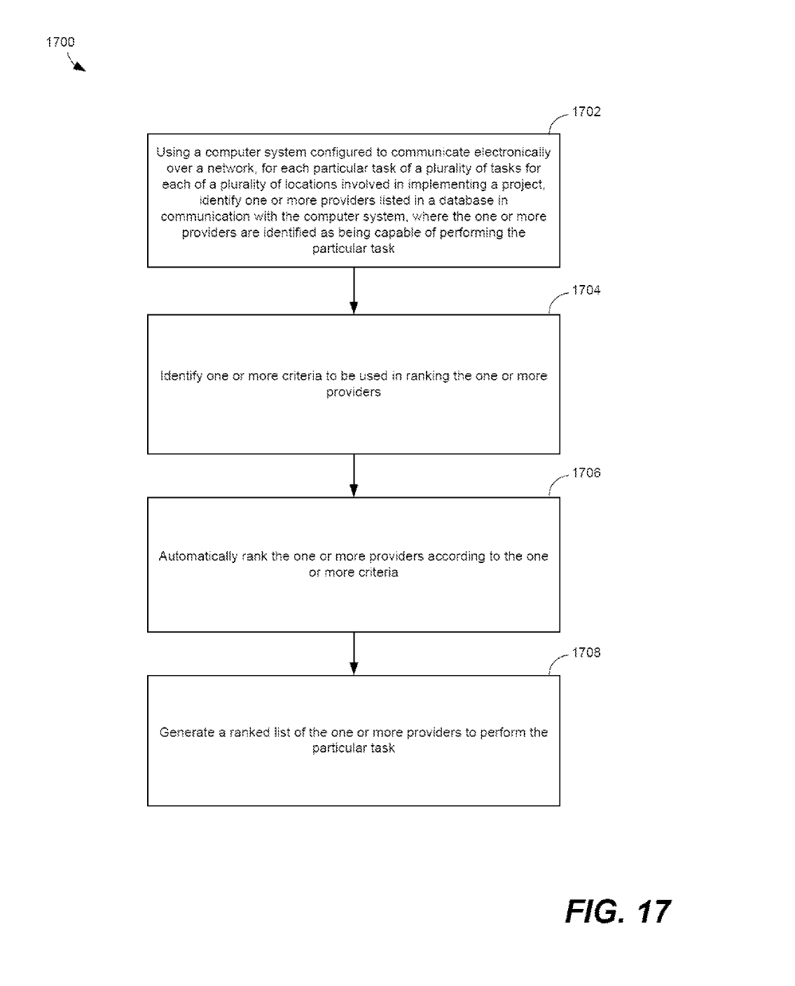

FIG. 17 is a flow diagram of a particular embodiment of a method 1700 of using automatic selection and ranking of potential providers of materials and services to implement a project. Using a computer system configured to communicate electronically over a network, at 1702, for each particular task of a plurality of tasks for each of a plurality of locations involved in implementing a project, one or more providers listed in a database in communication with the computer system are identified, where the one or more providers are identified as being capable of performing the particular task. At 1704, one or more criteria to be used in ranking the one or more providers are identified. Whether particular providers are determined to be capable of performing a particular task may be based on publicly available information, such as an industry classification (e.g., electrician, sells a particular product, or other qualifying factors, that may be derived from directories or other public information sources. The criteria for selecting one or more providers may be based on information stored the databases 302 (FIG. 3) or 402 and 452 (FIG. 4) such as whether particular providers are capable of performing a particular task may be based on cost, experience, past evaluations, and other factors as described with reference to FIGS. 10-12 and which may be directed to proprietary information maintained in the project management systems.

At 1706, the one or more providers are automatically ranked according to the one or more criteria, as also described with reference to FIGS. 10-12. At 1708, a ranked list of the one or more providers to perform the particular task is generated, as also previously described with reference to FIGS. 10-12. From this ranked list of providers, determining who will staff the project, project implementation may then proceed to determine the timing of the project implementation.

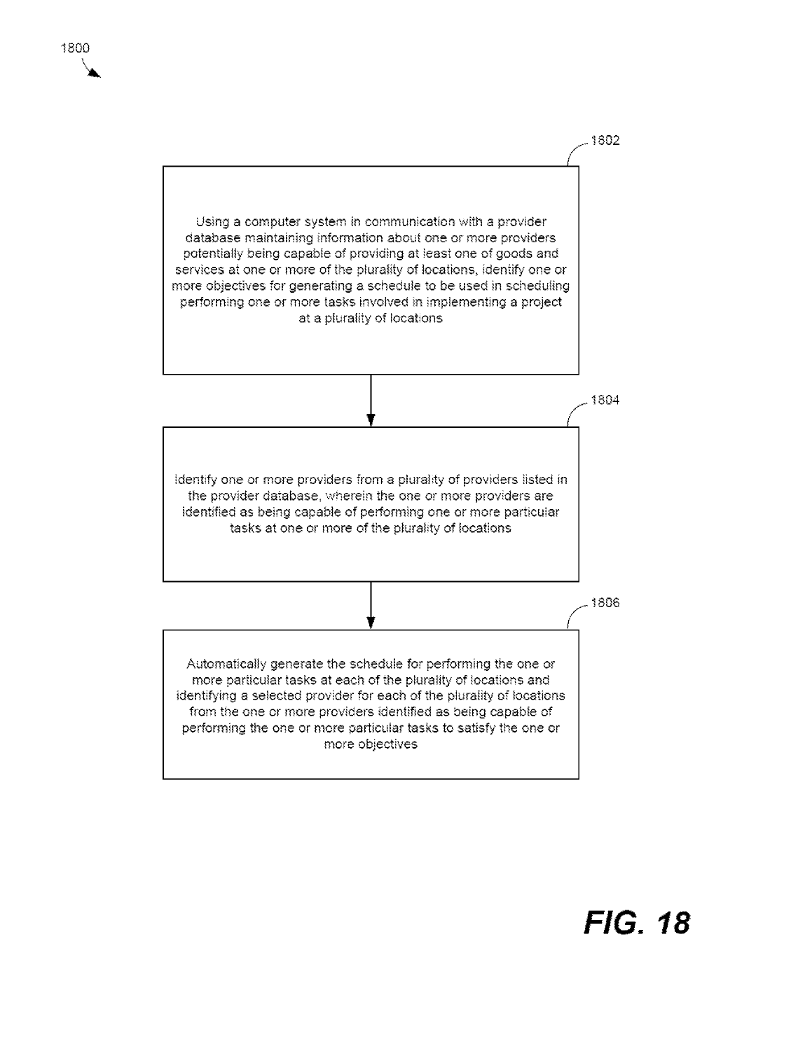

FIG. 18 is a flow diagram of a particular embodiment of a method 1800 for generating a schedule for implementation of a project. Using a computer system in communication with a provider database maintaining information about one or more providers potentially being capable of providing at least one of goods and services at one or more of the plurality of locations, at 1802, one or more objectives for generating a schedule to be used in scheduling performing one or more tasks involved in implementing a project are identified. As described with reference to FIGS. 14 and 15, such scheduling objectives may include lowest cost, shortest implementation time, use of local providers, or a combination of these and other factors.

At 1804, one or more providers are identified from a plurality of providers listed in the provider database, wherein the one or more providers are identified as being capable of performing one or more particular tasks at one or more of the plurality of locations. As described with reference to FIGS. 10-13 and FIGS. 16 and 17, the capability of providers may be determined based on information known about the providers regarding their suitability and, based on exchange of electronic request transmissions and responses, which of the suitable providers may be available and willing to perform particular tasks.

At 1806, from the list of the one or more providers identified as being capable of performing the one or more particular tasks, a schedule for performing the one or more particular tasks at each of the plurality of locations and identifying a selected provider for each of the plurality of locations is automatically generated to satisfy the one or more objectives, as described with reference to FIGS. 14 and 15.

Referring to FIGS. 16-18, it should be appreciated that project planning and implementation may employ one or more of the methods summarized in FIGS. 16-18. Tasks may be concentrated in particular groups and performance of those tasks may be automatically arranged through exchange of electronic communications as described with reference to FIG. 16. Particular providers may be selected based on specified criteria as described with reference to FIG. 17. An implementation schedule may be generated or revised automatically according to stated objectives as described with reference to FIG. 18.

Generation and review of electronic communications as well filtering and sorting potential providers and scheduling of said providers may be automatically performed by a suitably programmed computing system, such as the server 301 (FIG. 3) or the servers 401 and 451 (FIG. 4). These computer systems may include general purpose computing systems that are configured and programmed to perform the methods as described with reference to the preceding figures.

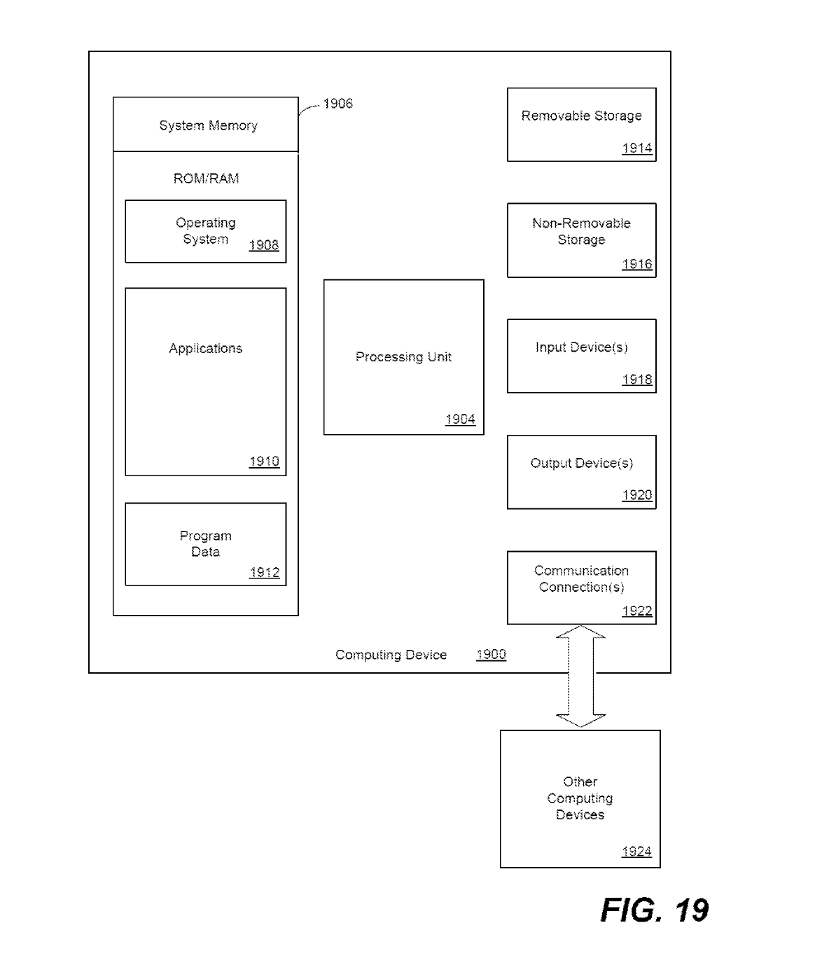

FIG. 19 illustrates a diagram of a representative computing system 1900 operable to support computer-implemented methods and to execute computer-executable instructions to facilitate project implementation as described in the present disclosure. The servers, workstations, and handheld wireless devices as previously described may include computing systems like the computing system 1900 illustrated and described with reference to FIG. 19.

Referring to FIG. 19, the computing system 1900 may include any of a number of forms of stationary or mobile computing devices. The computing device 1900 typically includes at least one processing unit 1904 and a system memory 1906. Depending on the exact configuration and type of computing device, the system memory 1906 may be volatile (such as RAM), non-volatile (such as ROM, flash memory, and the like) or some combination of the two. The system memory 1906 typically maintains an operating system 1908, one or more applications 1910, and program data 1912.

The computing device 1900 may also have additional features or functionality. For example, the computing device 1900 may also include additional data storage devices (removable and/or non-removable) such as, for example, magnetic disks, optical disks, or tape. Such additional storage is illustrated in FIG. 19 by removable storage 1914 and non-removable storage 1916. Computer storage media may include volatile and non-volatile, removable and non-removable media implemented in any method or technology for storage of information, such as computer readable instructions, data structures, program modules or other data. The system memory 1906, the removable storage 1914, and the non-removable storage 1916 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1900. Any such computer storage media may be part of the computing device 1900. The computing device 1900 may also have input device(s) 1918 such as a keyboard, mouse, pen, voice input device, touch input device, etc. Output device(s) 1920 such as a display, speakers, printer, etc., may also be included.

The computing device 1900 also may include one or more communication connections 1922 that allow the computing device 1900 to communicate with other computing devices 1924, such as over a network or a wireless network. The one or more communication connections 1922 are an example of communication media. Available forms of communication media typically carry computer readable instructions, data structures, program modules or other data in a modulated data signal such as a carrier wave or other transport mechanism and includes any information delivery media. By way of example, and not limitation, communication media may include wired media such as a wired network or direct-wired connection, and wireless media such as acoustic, RF, infrared and other wireless media. The term computer readable media as used herein includes both storage media and communication media.

While the disclosure has been has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Any of various elements or features recited herein is contemplated for use with other features or elements disclosed herein, unless specified to the contrary. Correspondingly, the invention that may be hereinafter claimed is intended to be broadly construed and interpreted, as including all such variations, modifications and alternative embodiments, within its spirit and scope.

1. A computer-implemented method for implementing a project at a plurality of locations, the computer-implemented method comprising:
using a computer system configured to communicate electronically over one or more networks:
dividing the project into a plurality of tasks for each of the plurality of locations, wherein the plurality of tasks are stored in a database of the computer system;
concentrating similar tasks for each of the plurality of locations such that similar tasks across the plurality of locations are collected in a task group;
for each particular task of the similar task in the task group, automatically generating one or more electronic request transmissions to each particular provider of one or more providers selected to request provision of at least one of services and materials for performance of the particular task;
receiving one or more electronic responses to the one or more electronic request transmissions; and
automatically reviewing one or more electronic responses to the one or more electronic request transmissions to determine whether each of the one or more providers has generated a positive response to the one or more electronic request transmissions requesting the provision of the at least one of services and materials.

2. The computer-implemented method of claim 1, wherein the one or more electronic request transmissions are generated from a template stored in the database of the computer system.

3. The computer-implemented method of claim 1, wherein the one or more electronic request transmissions are transmitted to each provider of the one or more providers using provider information stored in the database of the computer system.

4. The computer-implemented method of claim 3, wherein the one or more providers are automatically selected from a plurality of providers included in the provider information stored in the database of the computer system.

5. The computer-implemented method of claim 4, wherein the one or more providers are selected according to one or more criteria specified for performance of the plurality of tasks.

6. The computer-implemented method of claim 5, wherein the plurality of providers are automatically ranked by the computer system according to the one or more criteria.

7. The computer-implemented method of claim 5, wherein the one or more criteria include:
provider cost;
provider travel cost;
provider shipping cost;
satisfaction rating with regard to previous provision of at least one of services and materials;
experience; and
experience with performance of the particular task.

8. The computer-implemented method of claim 7, wherein the one or more criteria are specified by one or more decision makers and entered into the computer system.

9. The computer-implemented method of claim 8, wherein the one or more decision makers include at least one a project manager having at least partial responsibility for implementing the project, a task administrator having at least partial responsibility for completing one or more of the similar tasks collected in the task group, and a customer for whom the project is being implemented.

10. The computer-implemented method of claim 9, wherein the one or more criteria are prioritized by the decision maker prior to the computer system automatically ranking the one or more criteria.

11. The computer-implemented method of claim 10, wherein, in response to the automatic review of the one or more electronic responses to the one or more electronic request transmissions, the computer system determines that the one or more providers provides a negative response or fails to respond, the computer system automatically generates a new electronic request transmission to a next provider of the plurality of providers automatically ranked by the computer system.

12. The computer-implemented method of claim 4, further comprising automatically generating a schedule for implementing the project at the plurality of locations using the one or more providers.

13. The computer-implemented method of claim 12, wherein the schedule for implementing the project is generated according to one or more identified objectives.

14. The computer-implemented method of claim 13, wherein the identified objective includes at least one of:
lowest cost;
minimum implementation time for all of the plurality of locations; and
minimum disruption of regular activity at each of the plurality of locations.

15. The computer-implemented method of claim 12, further comprising automatically generating a revised schedule for implementing the project at the plurality of locations using the one or more providers in response to receiving an initial schedule for implementing the project and an identified objective, wherein the revised schedule serves the one or more identified objectives better than the initial schedule.

16. The computer-implemented method of claim 12, wherein, in response to the automatic review of the one or more electronic responses to the one or more electronic request transmissions, the computer system determines that the one or more providers has one of provided a negative response or has failed to respond, the computer system automatically generates an alert to a person in charge of the task group.

17. The computer-implemented method of claim 1, wherein in response to the automatic review of the one or more electronic responses to the one or more electronic request transmissions the computer system determines that the one or more providers has one of provided a negative response or has failed to respond, the computer system automatically generates a new electronic request transmission to a next provider of the plurality of providers automatically ranked by the computer system.

18. The computer-implemented method of claim 1, wherein the one or more electronic request transmissions for the particular task include one or more of a request to:
agree to provide the at least one of services and materials as specified in the one or more electronic request transmissions;
confirm that the at least one of services and materials will be provided as specified in the one or more electronic request transmissions;
confirm arrival of the materials at a particular location where the particular task is to be performed;
confirm arrival at the particular location for providing the services;
confirm commencement of the services; and
confirm completion of at least a portion of the particular task.

19. The computer-implemented method of claim 1, wherein the one or more electronic request transmissions generated by the computer system include one or more of:
electronic mail (e-mail);
a text message;
a synthesized voice message;
a recorded voice message; and
a custom format message adapted to be engaged using an application executing on a portable wireless device.

20. The computer-implemented method of claim 1, wherein the one or more electronic responses to the one or more electronic request transmissions include one or more of:
electronic mail (e-mail);
a text message;
a recorded voice message; and
a custom format message adapted to be engaged using an application executing on a portable wireless device.

21. The computer-implemented method of claim 20, wherein content of the one or more electronic responses includes:
an electronic acknowledgment;
an electronic signature of one of a provider and a customer representative of a customer for whom the project is being implemented;
an evaluation by the customer of satisfaction with performance of the particular task; and
a photograph representative of completion of the particular task.

22. The computer-implemented method of claim 1, further comprising generating one or more progress reports based on the one or more electronic request transmissions and the one or more electronic responses to the one or more electronic request transmissions indicative of progress of at least a portion of the plurality of tasks.

23. The computer-implemented method of claim 1, further comprising generating one or more invoices based on the one or more electronic responses to the one or more electronic request transmissions indicative of completion of at least a portion of the plurality of tasks.

24. The computer-implemented method of claim 1, further comprising initiating payment for the one or more providers based on the one or more electronic responses to the one or more electronic request transmissions indicative of one of progress toward performance and completion of at least a portion of the plurality of tasks.

25. The computer-implemented method of claim 1, wherein the computer system and the database are one of:
maintained by an enterprise for whom the project is being implemented; and
maintained by a project management enterprise retained by the enterprise for whom the project is being implemented; and
maintained by a third-party service provider retained by one of the enterprise for whom the project is being performed and the project management enterprise retained by the enterprise for whom the project is being performed.

26. The computer-implemented method of claim 1, wherein the computer system includes a primary computer system and a secondary computer system that both are configured to access the database, and wherein the primary computer system and the secondary computer system are configured to operate at least one of singly and in tandem.

27. The computer-implemented method of claim 1, wherein the database a primary database and a secondary database maintained and updated in parallel wherein the computer system is configured to access either the primary database and the secondary database in event of a failure by one of the primary database and the secondary database.

28. The computer-implemented method of claim 1, further comprising, upon at least one of the one or more providers providing at least one of services and materials for the performance of the particular task, updating the database to include information indicative of performance of the one or more providers in providing at least one of services and materials for the performance of the particular task.

29. A computer-implemented method for implementing a project at a plurality of locations, the computer-implemented method comprising:
using a computer system:
for each particular task of a plurality of tasks for each of a plurality of locations involved in implementing a project, identifying one or more providers listed in a database in communication with the computer system, wherein the one or more providers are identified as being capable of performing the particular task;
identifying one or more criteria to be used in ranking the one or more providers;
automatically ranking the one or more providers according to the one or more criteria; and
generating a ranked list of the one or more providers to perform the particular task.

30. The computer-implemented method of claim 29, further comprising automatically selecting a first ranked provider from the ranked list of the one or more providers as a selected provider.

31. The computer-implemented method of claim 29, further comprising prioritizing the one or more criteria used by the computer system in automatically ranking the one or more providers according to the one or more criteria.

32. The computer-implemented method of claim 31, wherein the one or more criteria used by the computer system in automatically ranking the one or more providers according to the one or more criteria are prioritized according to input provided by one or more decision makers.

33. The computer-implemented method of claim 32, wherein the one or more decision makers include at least one a project manager having at least partial responsibility for implementing the project, a task administrator having at least partial responsibility for completing one or more of the similar tasks collected in the task group, and a customer for whom the project is being implemented.

34. The computer-implemented method of claim 29, wherein the one or more criteria include:
provider cost;
provider travel cost;
provider shipping cost;
satisfaction rating with regard to previous provision of services or materials;
experience; and
experience with performance of the particular task.

35. The computer-implemented method of claim 29, further comprising automatically generating a schedule for implementing the project at the plurality of locations using the one or more providers.

36. The computer-implemented method of claim 35, wherein the schedule for implementing the project is generated according to one or more identified objectives.

37. The computer-implemented method of claim 36, wherein the identified objective includes at least one of:
lowest cost;
minimum implementation time for all of the plurality of locations; and
minimum disruption of regular activity at each of the plurality of locations.

38. The computer-implemented method of claim 35, further comprising automatically generating a revised schedule for implementing the project at the plurality of locations using the one or more providers in response to receiving an initial schedule for implementing the project and an identified objective, wherein the revised schedule better serves the one or more identified objectives than the initial schedule.

39. The computer-implemented method of claim 29, wherein the computer system is configured to communicate electronically over one or more networks, further comprising automatically generating one or more electronic request transmissions to the selected provider to provide at least one of services and materials for performance of the particular task.

40. The computer-implemented method of claim 39, wherein the one or more electronic request transmissions for the particular task include one or more of a request to:
agree to provide the at least one of services and materials as specified in the one or more electronic request transmissions;
confirm that the at least one of services and materials will be provided as specified in the one or more electronic request transmissions;
confirm arrival of the materials at a particular location where the particular task is to be performed;
confirm arrival at the particular location for providing the services;
confirm commencement of the services; and
confirm completion of at least a portion of the particular task.

41. The computer-implemented method of claim 39, wherein the one or more electronic request transmissions generated by the computer system include one or more of:
electronic mail (e-mail);
a text message;
a synthesized voice message;
a recorded voice message; and
a custom format message adapted to be engaged using an application executing on a portable wireless device.

42. The computer-implemented method of claim 39, further comprising the computer system:
automatically reviewing one or more electronic responses to the one or more electronic request transmissions to determine whether the selected provider has generated a positive response regarding providing the at least one of services or materials for performance of the particular task; and
upon determining that the selected provider provides a negative response or fails to respond, automatically revoking the one or more electronic request transmissions to the selected provider;
selecting a next ranked provider from the list of the one or more providers; and
generating one or more additional electronic request transmissions to the next ranked provider of the plurality of providers.

43. The computer-implemented method of claim 42, wherein the one or more responses to the one or more electronic request transmissions include one or more of:
electronic mail (e-mail);
a text message;
a recorded voice message; and
a custom format message adapted to be engaged using an application executing on a portable wireless device.

44. The computer-implemented method of claim 42, wherein content of the one or more responses includes:
an electronic acknowledgment;
an electronic signature of one of a provider and a customer representative of a customer for whom the project is being implemented;
an evaluation by the customer of satisfaction with performance of the particular task; and
a photograph representative of completion of the particular task.

45. The computer-implemented method of claim 42, further comprising generating one or more progress reports based on the one or more electronic request transmissions and the one or more electronic responses to the one or more electronic request transmissions indicative of progress of at least a portion of the plurality of tasks.

46. The computer-implemented method of claim 42, further comprising generating one or more invoices based on the one or more electronic responses to the one or more electronic requests indicative of completion of at least a portion of the plurality of tasks.

47. The computer-implemented method of claim 42, further comprising initiating payment for the one or more providers based on the one or more electronic responses to the one or more electronic request transmissions indicative of one of progress toward performance and completion of at least a portion of the plurality of tasks.

48. The computer-implemented method of claim 29, wherein the computer system and the database are one of:
maintained by an enterprise for whom the project is being implemented; and
maintained by a project management enterprise retained by the enterprise for whom the project is being implemented; and
maintained by a third-party service provider retained by one of the enterprise for whom the project is being performed and the project management enterprise retained by the enterprise for whom the project is being performed.

49. The computer-implemented method of claim 29, wherein the computer system includes a primary computer system and a secondary computer system that both are configured to access the database, and wherein the primary computer system and the secondary computer system are configured to operate at least one of singly and in tandem.

50. The computer-implemented method of claim 29, wherein the database a primary database and a secondary database maintained and updated in parallel wherein the computer system is configured to access either the primary database and the secondary database in event of a failure by one of the primary database and the secondary database.

51. A computer-implemented method for implementing a project at a plurality of locations, the computer-implemented method comprising:
at a computer system in communication with a provider database maintaining information about one or more providers potentially being capable of providing at least one of goods and services at one or more of the plurality of locations:
identifying one or more objectives for generating a schedule to be used in scheduling performing one or more tasks involved in implementing a project at a plurality of locations;
identifying one or more providers from a plurality of providers listed in the provider database, wherein the one or more providers are identified as being capable of performing one or more particular tasks at one or more of the plurality of locations; and
automatically generating the schedule for performing the one or more particular tasks at each of the plurality of locations and identifying a selected provider for each of the plurality of locations from the one or more providers identified as being capable of performing the one or more particular tasks to satisfy the one or more objectives.

52. The computer-implemented method of claim 51, wherein the one or more objectives includes at least one of:
lowest cost;
minimum implementation time for all of the plurality of locations; and
minimum disruption of regular activity at each of the plurality of locations.

53. The computer-implemented method of claim 51, further comprising automatically generating a revised schedule for implementing the project at the plurality of locations using the one or more providers identified as being capable of performing the one or more particular tasks in response to receiving an initial schedule for implementing the project in accordance with the one or more objectives, wherein the revised schedule better serves the one or more identified objectives than the initial schedule.

54. The computer-implemented method of claim 51, further comprising, for each particular task of one or more of the plurality of tasks:
identifying one or more criteria to be used in ranking the one or more providers for each of the plurality of locations;
automatically ranking the one or more providers for each of the plurality of locations according to the one or more criteria; and
generating a ranked list of the one or more providers to perform the particular task for each of the plurality of locations.

55. The computer-implemented method of claim 54, further comprising identifying the selected provider for each of the plurality of locations by selecting a next ranked provider from the ranked list of the one or more providers.

56. The computer-implemented method of claim 54, further comprising prioritizing the one or more criteria used by the computer system in automatically ranking the one or more providers according to the one or more criteria.

57. The computer-implemented method of claim 56, wherein the one or more criteria used by the computer system in automatically ranking the one or more providers according to the one or more criteria are prioritized according to input provided by one or more decision makers.

58. The computer-implemented method of claim 57, wherein the one or more decision makers include at least one a project manager having at least partial responsibility for implementing the project, a task administrator having at least partial responsibility for completing one or more of the similar tasks collected in the task group, and a customer for whom the project is being implemented.

59. The computer-implemented method of claim 54, wherein the one or more criteria include:
provider cost;
provider travel cost;
provider shipping cost;
satisfaction rating with regard to previous provision of services or materials;
experience; and
experience with performance of the particular task.

60. The computer-implemented method of claim 55, further comprising, wherein the computer system is configured to communicate electronically over one or more networks, automatically generating one or more electronic request transmissions to the selected provider.

61. The computer-implemented method of claim 60, wherein the one or more electronic request transmissions for the one or more particular tasks include one or more of a request to:
agree to provide the at least one of services and materials as specified in the one or more electronic request transmissions;
confirm that the at least one of services and materials will be provided as specified in the one or more electronic request transmissions;
confirm arrival of the materials at a particular location where the particular task is to be performed;
confirm arrival at the particular location for providing the services;
confirm commencement of the services; and
confirm completion of at least a portion of the particular task.

62. The computer-implemented method of claim 60, wherein the one or more electronic request transmissions generated by the computer system include one or more of:
electronic mail (e-mail);
a text message;
a synthesized voice message;
a recorded voice message; and
a custom format message adapted to be engaged using an application executing on a portable wireless device.

63. The computer-implemented method of claim 60, further comprising the computer system:
automatically reviewing one or more responses to the one or more electronic request transmissions to determine whether the selected provider has generated a positive response regarding providing the at least one of services or materials for performance of the one or more particular tasks; and
upon determining that the selected provider provides a negative response or fails to respond, automatically revoking the one or more electronic request transmissions to the selected provider;
selecting a next ranked provider from the list of the one or more providers; and
generating one or more additional electronic request transmissions to the next ranked provider of the plurality of providers.

64. The computer-implemented method of claim 63, wherein the one or more responses to the one or more electronic requests include one or more of:
electronic mail (e-mail);
a text message;
a recorded voice message; and
a custom format message adapted to be engaged using an application executing on a portable wireless device.

65. The computer-implemented method of claim 63, wherein content of the one or more responses includes:
an electronic acknowledgment;
an electronic signature of one of a provider and a customer representative of a customer for whom the project is being implemented;
an evaluation by the customer of satisfaction with performance of the particular task; and
a photograph representative of completion of the particular task.

66. The computer-implemented method of claim 63, further comprising generating one or more progress reports based on the one or more electronic request transmissions and the one or more electronic responses to the one or more electronic request transmissions indicative of progress of at least a portion of the plurality of tasks.

67. The computer-implemented method of claim 66, further comprising generating one or more invoices based on the one or more electronic responses to the one or more electronic request transmissions indicative of completion of at least a portion of the plurality of tasks.

68. The computer-implemented method of claim 67, further comprising initiating payment for the one or more providers based on the one or more electronic responses to the one or more electronic request transmissions indicative of one of progress toward performance and completion of at least a portion of the plurality of tasks.

69. The computer-implemented method of claim 51, wherein the computer system and the database are one of:
maintained by an enterprise for whom the project is being implemented; and
maintained by a project management enterprise retained by the enterprise for whom the project is being implemented; and
maintained by a third-party service provider retained by one of the enterprise for whom the project is being performed and the project management enterprise retained by the enterprise for whom the project is being performed.

70. The computer-implemented method of claim 51, wherein the computer system includes a primary computer system and a secondary computer system that both are configured to access the database, and wherein the primary computer system and the secondary computer system are configured to operate at least one of singly and in tandem.

71. The computer-implemented method of claim 51, wherein the database a primary database and a secondary database maintained and updated in parallel wherein the computer system is configured to access either the primary database and the secondary database in event of a failure by one of the primary database and the secondary database.
